(19) United States
(12) Patent Application Publication
(10) Pub. No.: US 2021/0058773 A1
(43) Pub. Date: Feb. 25, 2021

(54) TRANSFER/CLONING OF SECURITY CONTEXT

(71) Applicant: Convida Wireless, LLC, Wilmington, DE (US)

(72) Inventors: Svante ALNÅS, Lund (SE); Lars NORD, Lund (SE)

(73) Assignee: Convida Wireless, LLC, Wilmington, DE (US)

(21) Appl. No.: 16/766,293

(22) PCT Filed: Nov. 23, 2018
(86) PCT No.: PCT/EP2018/082317

§ 371 Date: May 22, 2020

Related U.S. Application Data
(60) Provisional application No. 62/635,221, filed on Feb. 26, 2018.

(30) Foreign Application Priority Data
Nov. 24, 2017 (SE) 1730328-0

(51) Int. Cl. H04W 12/00; H04L 9/08; H04L 9/14

(52) U.S. Cl. CPC H04W 12/0017; H04L 9/0838; H04W 4/70; H04W 12/00514; H04L 9/14

(57) ABSTRACT

Various examples generally relate to techniques of communicating using a security context of an encryption. Various examples specifically relate to performing negotiation of the security context.

### TECHNICAL FIELD

Various examples generally relate to techniques of communicating using a security context of an encryption. Various examples specifically relate to performing negotiation of the security context.

### BACKGROUND

Mobile communication is an integral part of modern life. Connected devices, e.g., in the Internet of Things (IOT) frameworks are proliferated and the number of terminals (user equipment; UE) connecting to networks is, therefore, expected to increase significantly in the near future.

Respectively, in the Third Generation Partnership Project (3GPP) New Radio (NR) or 5G framework, a new study “5G-IOT” will help to provide a framework to support large number of UEs and their respective requirements, e.g., in terms of latency, quality of service, reliability, power consumption, etc.

Typically, communication, specifically mobile communication, needs to be protected against unauthorized access of third parties. To this end, it is possible to transmit and/or receive (communicate) between a first node and the second node using a security context of an encryption, e.g., an end-to-end encryption (E2EE). Typically, when using E2EE, only those nodes in possession of the security context will be able to read the encrypted information. Any intermediate nodes, e.g., gateway nodes forwarding the encrypted information, will not be able to read or access the information. This mitigates a risk for eavesdropping by unauthorized third parties.

There are different technologies available for implementing the E2EE. One example technology includes the Open Mobile Alliance Device Management Security, see “Mobile Alliance (OMA) Technical Specification (TS) Device Management Security version 1.3 (May 24, 2016). An alternative technology that may be used is 3GPP NR Access Stratum (NAS) E2EE, see, e.g., 3GPP TS 33.401 version 15.0.0 (2017-06) Annex B, B.1 128-bit ciphering algorithm. Typically, a security context includes multiple parameters. In order to determine values for these parameters, a negotiation of the security context is performed between the end nodes of the E2EE.

Typically, performing the negotiation of the security context is slow and consumes significant resources, e.g., on communication channels and/or hardware resources at the participating end nodes. For example, performing the negotiation can be resource-consuming due to extra signalling and/or the required mathematic calculations to determine the values of the parameters of the security context. Therefore, in scenarios in which a large number of UEs and, therefore, potential end nodes to the E2EE are encountered, it can be difficult to accommodate for these resources.

### SUMMARY

Therefore, a need exists for advanced techniques of encryption. Specifically, a need exists for encryption techniques which mitigate or overcome at least some of the above-identified restrictions and drawbacks.

This need is met by the features of the independent claims. The features of the dependent claims define embodiments.

A method of operating a terminal node includes performing a negotiation of a first instance of the security context for a first encryption between the terminal node and a first node. Based on the negotiation of the first instance of the security context, a second instance of the security context is created. The second instance of the security context is for a second encryption between the terminal node and a second node. The method may include updating a first value of a dynamic parameter associated with the first instance of the security context in response to communicating with the first node using the first instance of the security context. The method may further include updating a second value of the dynamic parameter associated with the second instance of the security context in response to communicating with the second node using the second instance of the security context.

For example, the first encryption may be a first E2EE. For example, the second encryption may be a second E2EE.

Hence, in other words, when communicating using the first instance of the security context, the first value may be updated; while, when communicating using the second instance of the security context, the second value may be updated. The values may be updated prior to or after dispatching any message when communicating.

Communicating with the first node may include receiving and/or transmitting multiple instances of a message. Communicating with the second node may include receiving and/or transmitting multiple instances of the message. It would be possible to select between the first and second instances of the security context depending on a value of an indicator communicated along with the message.

The dynamic parameters may be selected from the group including: counter per message; transmit counter; receive counter; transmit and receive counter; random string/token; etc.

By such techniques, it is possible to selectively negotiate the first instance of the security context; and clone the second instance of the security context from the first instance of the security context. This reduces the overall resources required for setting up the first encryption and the second encryption.

A computer program product or a computer program includes program code. The program code may be executed by a processor. Executing the program code causes the processor to perform a method of operating a terminal node which includes performing a negotiation of a first instance of the security context for a first encryption between the terminal node and a first node. Based on the negotiation of the first instance of the security context, a second instance of the security context is created. The second instance of the security context is for a second encryption between the terminal node and a second node. The method may include updating a first value of a dynamic parameter associated with the first instance of the security context in response to communicating with the first node using the first instance of the security context. The method may further include updating a second value of the dynamic parameter associated with the second instance of the security context in response to communicating with the second node using the second instance of the security context

A terminal node includes control circuitry configured to perform: performing a negotiation of a first instance of a security context for a first end-to-end encryption between the terminal node and a first node; and based on the negotiation of the first instance of the security context: creating a second instance of the security context for a second end-to-end encryption between the terminal node and a second node; and updating a first value of a dynamic parameter associated with the first instance of the security context in response to communicating with the first node using the first instance of the security context; updating a second value of the dynamic parameter associated with the second instance of the security context in response to communicating with the second node using the second instance of the security context

A method of operating a first node includes performing negotiation of a first instance of a security context of a first encryption. The first encryption is between the first node and a terminal node. The method further includes creating a second instance of the security context based on said negotiation of the first instance of the security context. The second instance of the security context is for a second encryption between the second node and the terminal node. The method further includes providing the second instance to the second node.

For example, the first node and the second node may be part of the same trusted domain. As such, providing the second instance from the first node to the second node and retrieving the second instance from the first node may be implemented using encrypted control signalling; this control signalling may be encrypted using a further security context of a further encryption between the first node and the second node.

The method may optionally further include: when communicating with the terminal node using the first instance of the security context: updating a first value of a dynamic parameter associated with the first instance of the security context.

The method may optionally further include, when communicating with the terminal node using the first instance of the security context: encrypting a message using the first instance of the security context and transmitting the message with an indicator having a first value. When the second node communicates with the terminal node using the second instance of the security context, the second node may encrypt the message using the second instance of the security context and may transmit the message with the indicator having a second value. The terminal node may then select between respective first and second instances of the security context for decrypting the message based on the indicator.

A first node includes control circuitry is configured to perform: performing negotiation of a first instance of a security context of a first end-to-end encryption between the first node and a terminal node; and based on the negotiation of the first instance of the security context: creating a second instance of the security context for a second end-to-end encryption between a second node and the terminal node; and providing the second instance of the security context to the second node.

A method of operating a second node includes retrieving a second instance of a security context of a second encryption between the second node and a terminal node. The second instance is retrieved from a first node.

A second node includes control circuitry configured to perform: retrieve a second instance of a security context of a second encryption between the second node and a terminal node. The second instance is retrieved from a first node.

A method of operating a terminal node is provided. A first static parameter is known by the terminal node and a first node. For example, based on the first static parameter, a first security context for a first encryption between the terminal node and the first node may be negotiated. The method includes generating a second static parameter based on the first static parameter and at least one other parameter that is known to both the terminal node and the first node. The method also includes negotiating, using the generated second static parameter, a second security context for a second encryption between the terminal node and a second node that has received the second static parameter from the first node.

A computer program product or a computer program includes program code. The program code may be executed by a processor. Executing the program code causes the processor to perform a method of operating a terminal node. A first static parameter is known by the terminal node and a first node. For example, based on the first static parameter, a first security context for a first encryption between the terminal node and the first node may be negotiated. The method includes generating a second static parameter based on the first static parameter and at least one other parameter that is known to both the terminal node and the first node. The method also includes negotiating, using the generated second static parameter, a second security context for a second encryption between the terminal node and a second node that has received the second static parameter from the first node.

A terminal node includes control circuitry that is configured to generate a second static parameter based on a first static parameter and at least one other parameter that is known to both the terminal node and the first node. The control circuitry is also configured to negotiate, using the generated second static parameter, a second security context for a second encryption between the terminal node and a second node that has received the second static parameter from the first node.

A method of operating a first node is provided. A first static parameter is known by the terminal node and a first node. The method includes generating a second static parameter based on the first static parameter and at least one other parameter that is known to both the terminal node and the first node. The method also includes providing the second static parameter to the second node. The first static parameter is known by the terminal node and a first node.

A computer program product or a computer program includes program code. The program code may be executed by a processor. Executing the program code causes the processor to perform a method of operating a first node. A first static parameter is known by the terminal node and a first node. The method includes generating a second static parameter based on the first static parameter and at least one other parameter that is known to both the terminal node and the first node. The method also includes providing the second static parameter to the second node. The first static parameter is known by the terminal node and a first node.

A first node includes control circuitry configured to perform: generating a second static parameter based on a first static parameter and at least one other parameter that is known to a terminal node and the first node, the first static parameter being known by the terminal node and the first node. The control circuitry being for configured to provide the second static parameter to the second node. The first static parameter is known by the terminal node and a first node.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a network including multiple nodes communicating using E2EE according to various examples.

FIG. 2 schematically illustrates a security context according to various examples.

FIG. 3 is a flowchart of a method according to various examples, wherein FIG. 3 relates to cloning of a security context.

FIG. 4 is a flowchart of a method according to various examples, wherein FIG. 4 relates to a re-negotiation of a security context.

FIG. 5 is a flowchart of a method according to various examples, wherein FIG. 5 relates to a re-negotiation of a security context.

FIG. 6 is a signalling diagram illustrating communication using multiple instances of a security context according to various examples.

FIG. 7 is a signalling diagram illustrating communication using multiple instances of a security context according to various examples.

FIG. 8 is a signalling diagram illustrating communication using multiple instances of a security context according to various examples.

FIG. 9 schematically illustrates the architecture of a network according to various examples.

FIG. 10 schematically illustrates the architecture of a network according to various examples.

FIG. 11 schematically illustrates a transmission protocol stack used at a radio access network of the network according to various examples.

FIG. 12 schematically illustrates various states in which a UE connected to the network may be operated according to various examples.

FIG. 13 is a signalling diagram of a random access procedure according to various examples.

FIG. 14 schematically illustrates a control message to which application data may be piggybacked according to various examples.

FIG. 15 schematically illustrates a control message to which application data may be piggybacked according to various examples.

FIG. 16 schematically illustrates user plane routing and control plane routing of application data according to various examples.

FIG. 17 is a signalling diagram schematically illustrating user plane routing of application data according to various examples.

FIG. 18 is a signalling diagram schematically illustrating user plane routing of application data according to various examples, wherein FIG. 18 further schematically illustrates the various layers of the transmission protocol stack.

FIG. 19 is a signalling diagram schematically illustrating user plane routing of application data according to various examples, wherein FIG. 19 further schematically illustrates the various layers of the transmission protocol stack.

FIG. 20 is a signalling diagram schematically illustrating establishing context information for a user plane bearer according to various examples.

FIG. 21 schematically illustrates the context information according to various examples.

FIG. 22 is a signalling diagram schematically illustrating creating context information for a user plane bearer according to various examples.

FIG. 23 schematically illustrates a UE according to various examples.

FIG. 24 schematically illustrates a BS according to various examples.

FIG. 25 schematically illustrates a control plane mobility node according to various examples.

FIG. 26 schematically illustrates a gateway node according to various examples.

FIG. 27 is a flowchart of a method according to various examples.

FIG. 28 is a flowchart of a method according to various examples.

FIG. 29 is a flowchart of a method according to various examples.

FIG. 30 is a flowchart of a method according to various examples.

FIG. 31 is a flowchart of a method according to various examples.

FIG. 32 is a flowchart of a method according to various examples.

FIG. 33 is a flowchart of a method according to various examples.

FIG. 34 is a signalling diagram illustrating communication using a first and a second security context according to various examples.

FIG. 35. illustrates a key distribution and key derivation scheme for EPS.

FIG. 36. illustrates generating a new key from the key derivation scheme for EPS based on KNASenc and TMSI.

FIG. 37 is a flowchart of a method for use in a terminal node according to various examples.

FIG. 38 is a flowchart of a method for use in a first node according to various examples.

FIG. 39 is a flowchart of a method for use in a second node according to various examples.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques are described which facilitate communication of application data and control data in a network to which UEs can wirelessly connect.

Typically, application data originates from higher layers of a transmission protocol stack. For example, application data may be associated with applications or services implemented by the UE, e.g., executed in a runtime environment of an operating system of the UE or supported by the firmware of the UE in another manner. Typical applications may include: actuator control; sensor readout including measurements of physical observables such as temperature, pressure, brightness, volume, flow, acceleration, velocity, position, etc.; web browsing; graphical user interface (GUI); location-aware services; Internet access; HTTP; etc. For example, application data may originate from Layer 6 or Layer 7 of the transmission protocol stack according to the Open Systems Interface (OSI) framework. Differently, control data may originate from lower layers of the transmission protocol stack, e.g., from Layer 1, Layer 2, or Layer 3 of the transmission protocol stack according to the OSI framework. Such control data may be required to set up and maintain or release a connection between the UE and the network.

The techniques described hereinafter may be applied to, both, uplink (UL) data and downlink (DL) data. UL data is transmitted by the UE and received by the network; while DL data is transmitted by the network and received by the UE. For sake of simplicity, hereinafter, various examples are described with reference to UL data; however, it should be understood that respective techniques may be readily applied for DL data, as well. Depending on whether UL data or DL date is routed, the routing may take place in different nodes. For example, UL data may be routed in the RAN, specifically a base station (BS) of the radio access network (RAN); while DL data may be routed by a gateway node.

The techniques described herein may find application in various use cases. For example, the techniques described herein may be employed in connection with IOT devices. IOT devices may be configured to execute IOT applications such as measurement reporting, actuator control, etc. Typically, application data of IOT devices may be characterized by being limited in size (e.g., each measurement report of an IOT device may not be larger than 500 kB, optionally may not be larger than 50 kB). On the other hand, reliability in the communication of application data of IOT devices is typically required to be high. For example, in application fields such as actuator control and/or sensor readout, it can be decisive that the respective application data is delivered timely and uncorrupted.

One example use case involves data delivery of application data via the control plane. The application data may be non-Internet Protocol (IP) data. See 3GPP TS 23.682 version 14.0.0 (2016-06): section 4.5.14 “Non-IP Data Delivery”. The support of application data via the control plane is part of control plane (CP) optimization (CIoT), see 3GPP TS 24.301 version 15.0.0 (2017-09). This technique enables support of efficient transport of data, both of non-IP and IP application data, as well as Short Messages (SMS) over the CP without triggering Data Radio Bearer establishment at the radio access network (RAN). Thus, instead of natively communicating the application data via the user plane (UP), the application data is diverted to the CP by encapsulating the application data in a control signalling messages. Therefore, the application data is forwarded via the CP. This helps to reduce latency and control signalling overhead and reducing power consumption. The application data received from upper layers can be included in an information field “dedicatedInfoNAS” for an NB-IoT UE, see 3GPP TS 36.331 version 14.0.0 (2016-09), section 5.6.2.3. For routing the application data, it is possible to set up a CP bearer, see 3GPP TS 23.682, Version 14.0.0 (2016-06), section 5.13.1. Here, a CP mobility node, specifically the Mobile Management Entity (MME) in the 3GPP LTE 4G framework is responsible to set-up and maintain the CP bearer. The techniques described herein may find application in such a CIoT framework. Hence, an example framework that may benefit from the techniques described herein is 3GPP NB-IOT, e.g., in connection with 3GPP 5G.

However, the techniques described herein may be readily applied to other communication protocols. One example includes Machine Type Communication (MTC). A further example includes Transmission Control Protocol/Internet Protocol (TCP/IP) which could be used to transport the application data, and still the lower layers could utilize the techniques described herein for delivering/receiving the IP packets.

According to the techniques described herein, it may be possible to securely communicate data using a security context of an encryption. Hereinafter, reference is specifically made to E2EE, albeit generally the techniques may also be applied for other kinds and types of encryption.

Specifically, according to the techniques described herein, it is possible to set up the security context efficiently, i.e., with low latency and/or limited resources, e.g., in terms of control signalling between the participating end nodes and/or computational resources. According to examples described herein, this is achieved by negotiating a first instance of a security context of an E2EE and then creating a second instance of the security context based on said negotiation of the first instance of the security context. The first instance of the security context may then be used in connection with communicating between a terminal node and a first node; while the second instance of the security context may be used in connection with communicating between the terminal node and a second node which is different from the first node.

As such, the second node may not be required to perform a distinct negotiation of its security context; rather, the second node may benefit from the negotiation of the security context between the terminal node and the first node. This is achieved by creating multiple instances of the security context. Such multiple instantiation of the security context may also be referred to as cloning the security context. This helps to reuse a once negotiated security context between multiple nodes. Therefore, the overall resources required to facilitate end-to-end encrypted communication between the terminal node and the multiple end nodes can be significantly reduced.

Some techniques for E2EE rely on a security context which includes, both, one or more static parameters, as well as one or more dynamic parameters. Typically, a value of each static parameter is fixedly set when performing the negotiation of the security context.

Examples of static parameters include a cryptographic key, a bearer or tunnel identity, etc. Differently, the value of dynamic parameters may change from each cryptographic event to cryptographic event, i.e., may change from each encryption event to encryption event or from decryption event to decryption event or from message transmission to message transmission or from message reception to message reception. It is possible that a seed value of the dynamic parameter is determined when performing the negotiation of the security context. Then, the subsequent change of the value of the dynamic parameter may be based on the seed value. For example, it would be possible that the seed value corresponds to the start value of the dynamic parameter, starting from which the value of the dynamic parameter is repetitively incremented or, generally, changed for each cryptographic event. Examples of such dynamic parameters include: a counter such as a session counter, and a random number which, e.g., may be bi-directionally updated from cryptographic event to cryptographic event.

Communication between different end nodes may encounter a different sequence of cryptographic events. This may be, e.g., due to different signalling loads, etc. This leads to the finding that the values of a dynamic parameter typically will exhibit a different evolution over the course of time for different instances of a security context. In other words, over the course of time there will be a tendency of values of a dynamic parameter associated with different instances of a security context to diverge. To accommodate for this divergent evolution of the values of a dynamic parameter for different instances of a security context, it is possible to separately implement the multiple instances of the security context. Hence, the various values of a dynamic parameter of different instances of the security context may be independently tracked and maintained. On the other hand, if—e.g., due to detection of an untrusted security level at a given instance of the security context—re-negotiation of the security context becomes necessary, this re-negotiation may be performed for a single instance of the security context and the remaining instances of the security context may then be updated accordingly. This helps to provide for synchronization between the multiple instances of the security context, thereby mitigating a risk for failures in a cryptographic event, e.g., due to outdated values of the dynamic parameter.

Such techniques of securely communicating data based on an E2EE may find application in various use cases. In one exemplary use case, it may be possible to securely communicate application data. According to some examples, the application data may be piggybacked to a control message which, e.g., may be communicated on a wireless link between a BS and a UE. For example, the control message may be a Layer 3 control message, sometimes also referred to as Radio Resource Control (RRC) control message. For example, the control message may be communicated on a control channel implemented on the wireless link between the UE and the BS. For example, the control message may be communicated via a Signalling Radio Bearer (SRB) established between the UE and the BS. With respect to the 3GPP Long Term Evolution (LTE) 4G protocol, details of the RRC layer are described in 3GPP TS 36.331 version 14.0.0. For example, CIoT techniques may be employed.

Generally, Layer 3 according to the OSI model may provide for functionality selected from the group including: establishment of radio bearers; release of radio bearers; reconfiguration of radio bearers; broadcast of system information; mobility procedures including paging and wake up; etc.

Piggybacking application data to a control message may refer to: including the application data in an information field of the control message. For example, the application data may be included in a further control message included in the information field. The information field may or may not be reserved exclusively for the purpose of carrying the application data. For example, the same information field may in some instances be used for carrying control data—such as Layer 3 or Layer 2 control data—; while in other instances of communication of the control message, this information field may be used for carrying the application data. For example, it would be possible that the information field is dedicated to including NAS control data and the application data is included in this NAS information field. The control message may be sent on a wireless link via a SRB. The Access Stratum (AS) security might not yet be enabled when sending the control message; to protect the application data the NAS message can be encrypted using an E2EE on NAS layer. In this example, the information field may include application data which is encrypted, e.g., on NAS-layer level. It would be possible that the NAS control message—beyond the application data—also includes NAS control data, e.g., in the same or a different information field which also includes the application data. Again, it would be possible that such control data—which is included in the control message beyond the application data—is Layer 3 control data.

Thus, generally, multiple instances of the control message may be communicated at different times; for example, a first instance of the control message may include control data in the information field, while a second instance of the control message may include the application data in the information field. Thereby, the control message may be flexible used for conveying application data and control data, depending on the particular circumstances. Along with those different instances of the control message, different instances of a security context for E2EE may be used.

According to various examples, techniques are provided for efficiently routing such application data—communicated in a control message via the wireless link between the BS and the UE—in the core network (CN). Specifically, according to the techniques described herein, it is possible that the application data is routed via a user-plane (UP) node of the CN. Hence, even though the application data may be piggybacked to the control message in the RAN when communicating the control message via the wireless link between the BS and the UE, it is possible that the application data is then diverted by not forwarding the application data to the CP of the CN, but by rather routing the application data to the UP of the CN. Switch point functionality may be implemented by a BS or another node; the switch point functionality may route control data included in a first instance of the control message to the CP and may route application data included in a second instance of the control message to the UP.

As will be appreciated, due to the switch point functionality, it is possible that the UE needs to perform E2EE for different end nodes, i.e., a UP node or a CP node, depending on, e.g., whether application data or control data is included in the control message or depending on the originating layer of a transmission protocol stack of the respective data. By means of the techniques described herein, it is possible to clone a once negotiated security context between those different endpoints. Then, for different instances of the control message, different instances of a security context of E2EE can be used—thereby, attributing to the different end nodes encountered due to the switch point functionality. In other examples, it becomes possible to determine the second security context based one the first security context. Specifically, it would be possible that a second cryptographic key of the second security context is determined based on a first cryptographic key and one or more further parameters. Then, the second security context can be negotiated between the respective nodes. This may not require sharing security contexts between various different nodes.

For example, by cloning the once negotiated security context, it is not required to renegotiate a further security context. This can reduce the overhead and reduce the latency. For example, the overhead and latency may be increased in the further example in which the second security context is determined based on the first cryptographic key; on the other hand, this scenario may mitigate the risk of compromising the first cryptographic key. Thus, by selecting between such scenarios of (i) cloning and (ii) using the first cryptographic key to determine the second security context, a balance between reduced overhead/latency and reduced security may be taken into account.

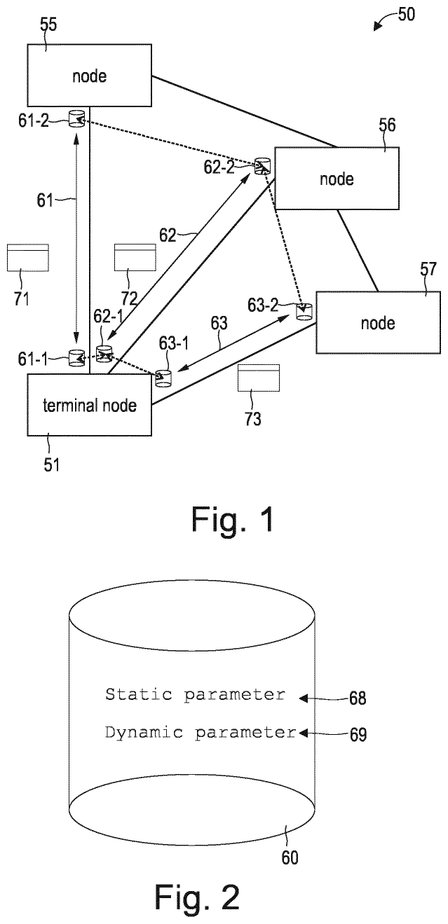

FIG. 1 schematically illustrates a network 50. For example, the network 50 may be a fixed-wire or wireless network. For example, the network 50 may operate according to OMA and/or 3GPP signalling.

The network 50, in the example of FIG. 1, includes a terminal node 51 and three further nodes 55, 56, 57. The terminal node 51 and the node 55 can communicate using an E2EE 61. The terminal node 51 and the node 56 can communicate using an E2EE 62. The terminal node 51 and the node 57 can communicate using an E2EE 63.

While in the scenario of FIG. 1, the intermediate nodes between the terminal node 51 and the respective one of the nodes 55-57 are not illustrated, generally, communication between the terminal node 51 and the respective end node 55-57 may be a multi-hop communication with involved intermediate nodes. The E2EE 61-63 may not be transparent to these intermediate nodes.

For communicating using the E2EE 61, a respective security context 61-1 is maintained at the terminal node 51 and a respective counterpart security context 61-2 is maintained at the node 55. For communicating using the E2EE 62, a respective security context 62-1 is maintained at the terminal node 51 and, furthermore, a respective counterpart security context 62-2 is maintained at the node 56. For communicating using the E2EE 63, a respective security context 63-1 is maintained at the terminal node 51 and, furthermore, a respective counterpart security context 63-1 is maintained at the node 57.

Thereby, a message 71 communicated between the terminal node 51 and the node 55 can be protected using the E2EE 61, based on the security context 61-1 and the security context 61-2. Likewise, a message 72 communicated between the terminal node 51 and the node 56 can be protected using the E2EE 62 and a message 73 communicated between the terminal node 51 and the node 57 can be protected using the E2EE 63.

Generally, it would be possible that inter-related security contexts 61-1, 61-2, and 62-1, 62-2, and 63-1, 63-2 of an E2EE 61-63 are at least partly different or are the same.

In the scenario of FIG. 1, it can be desirable to avoid a need for individual negotiation of each one of the security context 61-1, 61-2, as well as 62-1, 62-2, as well as 63-1, 63-2.

To achieve this, it would be possible to clone the security context 61-1, to thereby obtain the security contexts 62-1 and 63-1 as different instances of the security context 61-1. Likewise, it would be possible to clone the security context 61-2, to thereby obtain the security contexts 62-2 and 63-2 as different instances of the security context 61-2 (such cloning is illustrated in FIG. 1 using the dotted arrows).

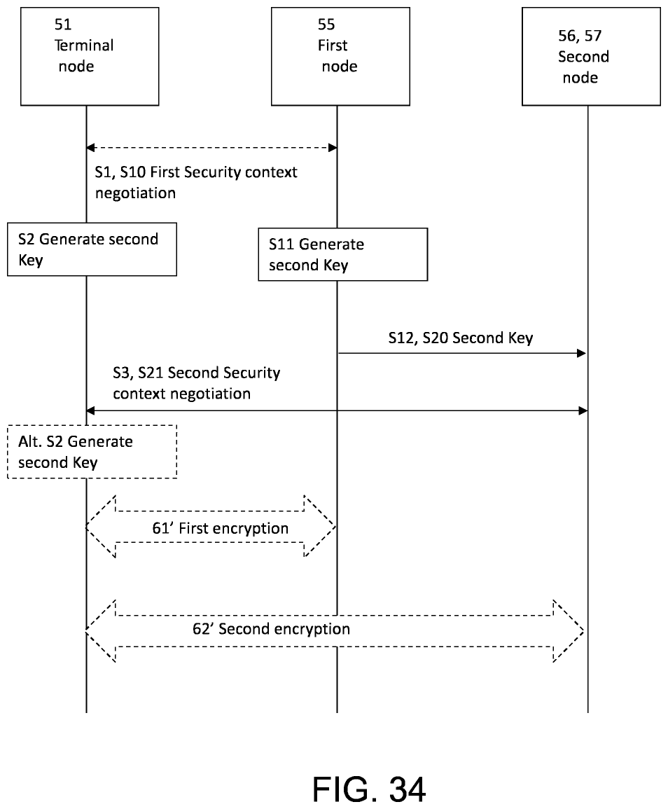

In other examples, it would be possible to determine the security context 62-1 based, e.g., a cryptographic key of the security context 61-1 and one or more further parameters known to terminal node 51 and the first node 55, e.g., a subscriber identity associated with the terminal node 51. This second example will be described later in detail, in connection with FIG. 34 to FIG. 39.

FIG. 2 illustrates aspects with respect to an example implementation of a security context 60. For example, the security context 60 according to the scenario of FIG. 2 may be used to implement any one of the security contexts 61-1, 61-2, 62-1, 62-2, 63-1, 63-2 according to the scenario of FIG. 1.

The security context 60 includes a static parameter 68. A value of the static parameter is fixedly set based on the negotiation of the security context 60. For example, the static parameter may include a tunnel identity or bearer identity, a random number, or a cryptographic key. As a general rule, it is possible that the security context 60 includes more than a single static parameter 68.

The security context 60 also includes a dynamic parameter 69. Examples of such dynamic parameters include: a counter value and a random number. Differently to the static parameter 68, the value of the dynamic parameter 69 is changed from cryptographic event to cryptographic event. For example, for each message 71-73 communicated using the respective E2EE 61-63, it would be possible to change the value of the dynamic parameters 69. Again, as a general rule, it would be possible that the security context 60 includes more than a single dynamic parameter 69.

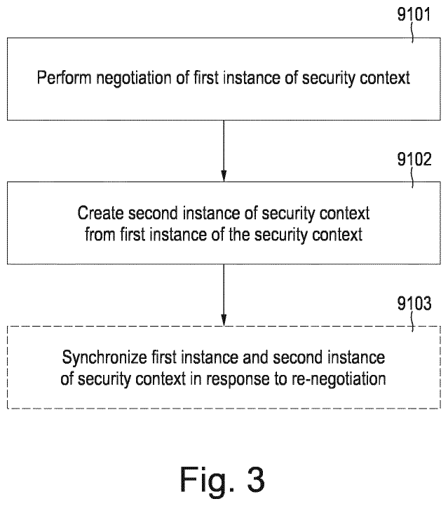

FIG. 3 is a flowchart of a method according to various examples. FIG. 3 illustrates aspects with respect to cloning of a security context, thereby providing different instances of the security context from the respective first instance of the security context that is cloned. For example, the method according to the scenario of FIG. 3 may be employed in connection with the scenario according to FIG. 1 to clone the security context 61-1, 61-2, to avoid having to negotiate the security contexts 62-1, 62-2, and 63-1, 63-2 individually.

Initially, at block 9101, a negotiation of a first instance of a security context is performed. For example, referring to the scenario of FIG. 1, it would be possible that the security context 61-1 and the security context 61-2 is negotiated between the terminal node 51 and the node 55. This corresponds to negotiating a first instance of the security context 61-1, 61-2.

Performing the negotiation of the security context at block 9101 may include exchanging values for one or more static parameters between the respective nodes; and/or exchanging seed values of one or more dynamic values between the respective nodes. Performing the negotiation of the first instance of the security context at block 9101 may also include: performing mathematic calculations in order to determine values for one or more static parameters and/or seed values for one or more dynamic parameters.

Next, in block 9102, a second instance of the security context is created from the first instance of the security context. In other words, in block 9102, it is possible to create the second instance of the security context based on said negotiation of the first instance of the security context of block 9101. For example, referring to the scenario of FIG. 1, it would be possible that the security context 62-2 is created as a second instance from the first instance of the security context 61-2. Alternatively or additionally, it would be possible to create the security context 62-1 as the second instance from the security context 61-1 which therefore implements the first instance. Similar considerations also apply for the security context 63-1, 63-2 of the E2EE 63.

There are generally various options available for creating the second instance of the security context from the first instance of the security context at block 9102. In a first option, it would be possible that the second instance of the security context is created by copying the first instance of the security context: this may involve duplicating the values of each parameter of the first instance of the security context. For example, it would be possible that a seed value for a dynamic parameter is determined when performing the negotiation of the first instance of the security context at block 9101; then, this seed value may be adhered also for the second instance of the security context at block 9102. Then, when performing cryptographic events using the first instance of the security context, a respective first value of the dynamic parameter associated with the first instance of the security context may be updated based on the seed value—e.g., incremented away from the seed value or by random modifications of the seed value. Likewise, also a second value of the dynamic parameters associated with the second instance of the security context may be updated based on that the seed value when performing cryptographic events using the second instance of the security context. Thus, such techniques which may generally be referred to as cloning of a security context to obtain different instances of the security context may implement a common starting point for a dynamic parameter.

In a further option, the second instance of the security context may be created by modifying, to a smaller or larger degree, the first instance of the security context. For example, this may involve changing one or more values of parameters of the first instance of the security context when creating the second instance of the security context. For example, a translation of a value of a static parameter and/or dynamic parameter may be performed. On the other hand, it may not be required to fully re-execute any mathematical algorithm which has been executed as part of block 9101 when executing block 9102; thereby, reducing the required computational resources.

Once block 9102 has been executed, the first instance of the security context is available for communicating between a terminal node and a first node; and the second instance of the security context is available for communicating between the terminal node and a second node. To this end, it may be possible to provide the second instance of the security context to the second node and/or provide the first instance of the security context to the first node. Then, the first node may maintain the first instance of the security context and the second node may maintain the second instance of the security context.

The terminal node may maintain, both, the first instance of the security context, as well as the second instance of the security context. Hence, a first value of a dynamic parameter associated with the first instance of the security context may be updated in response to communicating between the terminal node and the first node using the first instance of the security context; while a second value of the dynamic parameter associated with the second instance of the security context may be updated in response to communicating between the terminal node and the second node using the second instance of the security context. This allows for the possibility of the first value to diverge from the second value.

Due to such divergence of the first value of the dynamic parameter with respect to the second value of the dynamic parameter, at some point in time, it may be required to synchronize the first instance and the second instance of the security context, namely in response to a re-negotiation of either the first instance of the security context or the second instance of the security context. This may be optionally performed at block 9103. This helps to align the various instances of the security context, even if the values of the respective dynamic parameters are separately adjusted and may have diverged.

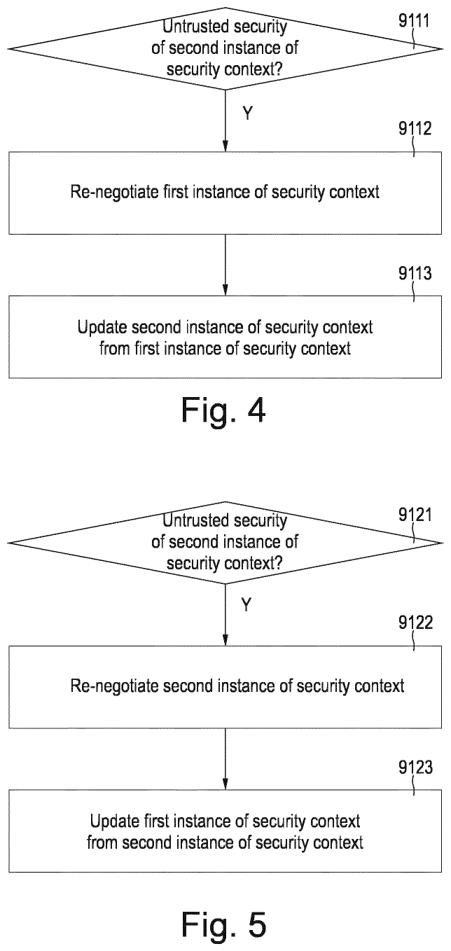

Details with respect to this synchronization of the first instance and the second instance are illustrated in connection with FIGS. 4 and 5.

FIG. 4 is a flowchart of a method according to various examples. FIG. 4 illustrates aspects with respect to synchronizing multiple instances of a security context. For example, the method according to FIG. 4 could be executed as part of block 9103 of FIG. 3.

FIG. 3 illustrates synchronization in a master-slave scenario. Here, if an untrusted security level is detected for the second instance of the security context, the first instance of the security context is re-negotiated. Hence, the first instance acts as a master from which the second instance is derived.

Initially, at block 9111, an untrusted security level is detected when communicating using the second instance of the security context. There are various scenarios conceivable which may lead to detection of the untrusted security level at block 9111. In a first example, the timeout of a re-negotiation timer may lead to detecting an untrusted security level. By provisioning a respective re-negotiation timer, it can be ensured that, at a given periodicity, the security information is re-negotiated. Thereby, it is not necessary to rely on long-lived or outdated security contexts. This reduces the risk of compromising security contexts over an extended duration. Another reason for detecting an untrusted security level at block 9111 can be non-matching security contexts at the participating endpoints of an E2EE. For example, referring to the scenario of FIG. 1, it would be possible that the security context 62-1 and the security context 62-2 of the E2EE 62 between the terminal node 51 of the node 56 do not match. This may occur where the value of a dynamic parameter is adjusted, e.g., at the terminal node 51 and with respect to the security context 62-1, but not adjusted—e.g., due to a transmission failure, at the node 56 for the security context 62-2. Then, decryption of any subsequent communication of the message 72 may fail, because the respective other node may not be able to decrypt the encrypted message 72. The respective values of the dynamic parameter associated with the security context 62-1 at the security context 62-2 may be out-of-sync.

Then, in response to detecting the untrusted security level of the second instance of the security context at block 9111, a re-negotiation of the first instance of the security context is performed at block 9112. Then, at block 9113, the second instance of the security context is updated from the first instance of the security context, based on the re-negotiation of block 9112.

FIG. 5 is a flowchart of a method according to various examples. FIG. 5 illustrates aspects with respect to performing a re-negotiation of a security context. For example, the method according to the scenario of FIG. 5 could be executed as part of block 9103 according to FIG. 3. The method according to the example of FIG. 5 generally corresponds to the method according to the example according to FIG. 4.

FIG. 5 illustrates synchronization in a peer scenario. Here, if an untrusted security level is detected for the second instance of the security context, the second instance of the security context is re-negotiated between the second node and the terminal—without having to rely on the first node to perform the re-negotiation.

Block 9121 generally corresponds to block 9111. In block 9121, an untrusted security level is detected when communicating using the second instance of the security context. Again, various scenarios are conceivable which may lead to detection of the untrusted security level at block 9121.

Next, at block 9122, a re-negotiation of the second instance of the security context is performed. This is different to the scenario of FIG. 4 where, at block 9112, the first instance of the security context is re-negotiated.

Next, at 9123 of the method according to FIG. 5, the first instance of the security context is updated from the second instance of the security context, i.e., based on the re-negotiation of block 9122.

From a comparison of FIGS. 4 and 5 it follows that in the scenario of FIG. 4, the first instance can implement a master instance functionality and the second instance (as well as any further instance created based on the negotiation of the first instance) may implement a slave functionality. Here, the master instance may be initially negotiated and, subsequently, re-negotiated; and any slave instances may be created and updated based on such negotiation and re-negotiation of the master instance. Such an approach having a master—slave hierarchy may have certain advantages in view of minimizing attack vectors and coordinating handling of security contexts across multiple nodes. Differently, the scenario according to FIG. 5—where multiple instances of the security context are peers in terms of hierarchy—load-balancing may be achieved. For example, when detecting an untrusted security level of the second instance of the security context, it may be possible to select between execution of the method according to FIG. 4 and execution of the method according to FIG. 5 depending on available resources at the first node participating in the re-negotiation of the first instance of the security context at block 9112 and the second node participating in the re-negotiation of the second instance of the security context at block 9122.

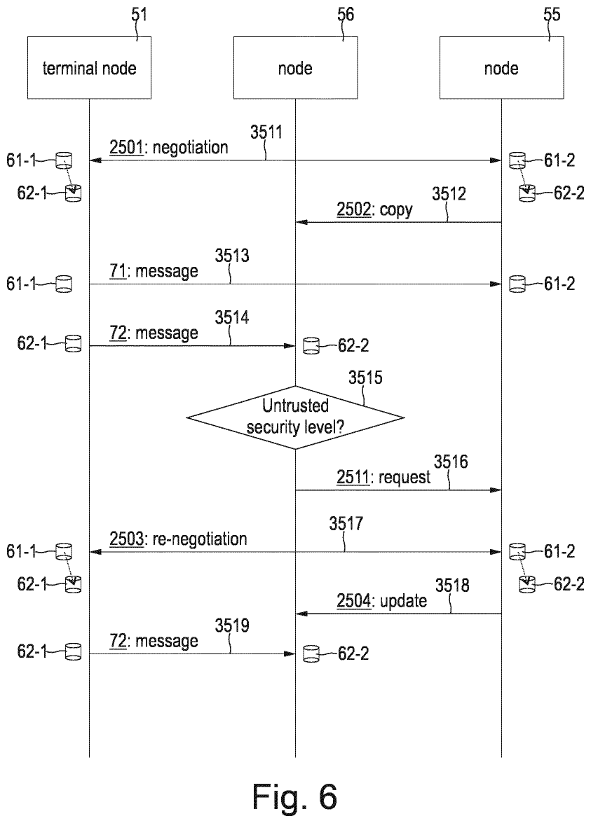

FIG. 6 is a signalling diagram illustrating aspects with respect to cloning security contexts.

At 2501, the terminal node 51 and the node 55 each perform negotiation of the respective security context 61-1, 61-2. This may involve bidirectional control signalling 2501. The security context 61-1 implements a first instance and a second instance of the security context is created, thereby yielding the security context 62-1. Likewise, the security context 61-2 implements a first instance, and the second instance is created, thereby yielding the security context 62-2.

At 3511, it would be possible to also rely on certain information stored for the terminal node 51 and/or the node 55 in a data repository. For example, a cryptographic key may be derived from a unique identity of the terminal node 51 and/or the node 55 retrieved from the repository.

The terminal node 51 then maintains the first instance of the security context 61-1 and the second instance of the security context 62-1. The node 55 provides the second instance of the security context 62-2 in a respective control message 2502 to the node 56, at 3512.

Next, at 3513, the terminal node 51 transmits an encrypted message 71. The message 71 is encrypted using the first instance of the security context 61-1. The node 55 receives the encrypted control message 71 and decrypts the encrypted control message using the respective first instance of the security context 61-2.

At 3514, the terminal node 51 transmits the encrypted message 72. The message 72 is encrypted using the respective second instance of the security context 62-1. At 3514, the node 56 receives the encrypted control message 72 and decrypts the encrypted control message 72 using the respective second instance of the security context 62-2.

At 3515, an untrusted security level is detected when communicating using the second instance of the security context 62-2. This may be due to, e.g., timeout of the re-negotiation timer or failure in decrypting the encrypted message 72.

Then, in response to detecting the untrusted security level at 3515, next, at 3516, a request control message 2511 is transmitted by the node 56 and received by the node 55. In response to receiving the request control message 2511, the node 55 performs re-negotiation of the first instance of the security context 61-2. Also, the terminal node 51 participates in the re-negotiation of the respective first instance of the security context 61-1. Respective control signalling 2503 between the terminal node 51 and the node 55 at 3517 may, generally, correspond to the control signalling 2501.

Next, at 3518, an update of the second instance of the security context 62-2 is provided by the node 55 to the node 56 based on the re-negotiation of 3517. A respective control message 2504 is transmitted by the node 55 and received by the node 56.

Then, optionally, at 3519, the message 72 may be re-transmitted using the updated second instances of the security context 62-1, 62-2.

The scenario of FIG. 6 generally corresponds to the master-slave hierarchy when synchronizing multiple instances of a security context as discussed with respect to FIG. 4.

FIG. 6 illustrates a scenario where the node 55 implements master functionality and the node 56 implements slave functionality. Specifically, negotiation and re-negotiation of the security context is handled by the node 55.

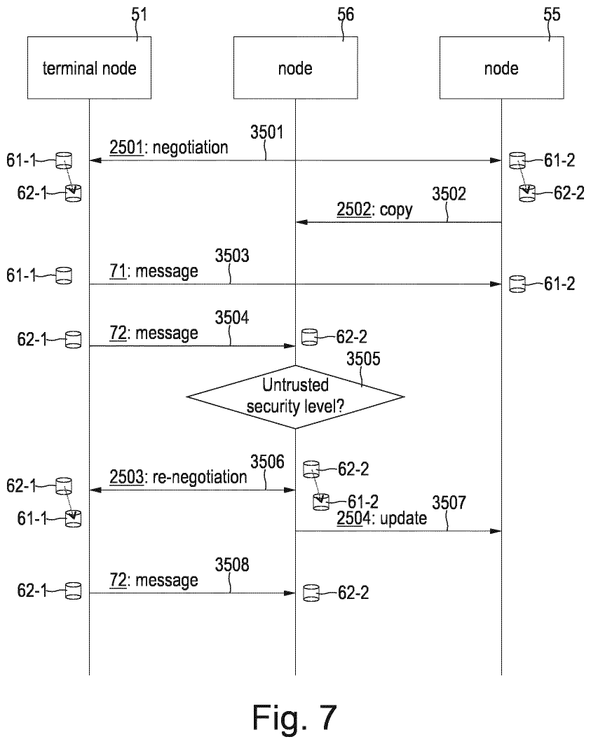

FIG. 7 is a signalling diagram illustrating aspects with respect to cloning a security context. The scenario of FIG. 7 generally corresponds to the scenario of FIG. 6.

Specifically, 3501 corresponds to 3511. 3502 corresponds to 3512. 3503 corresponds to 3513. 3504 corresponds to 3514. 3505 corresponds to 3515.

Then, the node 56 performs re-negotiation of the second instance of the security context 62-2; likewise, the terminal node 51 participates in the re-negotiation of the second instance of the security context 62-1, at 3506. Respective control signalling 2503 is communicated between the terminal node 51 and the node 56.

Then, the respective first instances of the security context 61-1, 61-2 are updated and a respective control message 2504 is communicated between the node 56 and the node 55 to provide the update of the first instance 61-2, 3507. 3508 corresponds to 3519.

FIG. 7 illustrates a scenario where the master-slave hierarchy between the nodes 55, 56 is not implemented with respect to the synchronization of multiple instances of the security context. As such, the scenario of FIG. 7 generally corresponds to the scenario of FIG. 5.

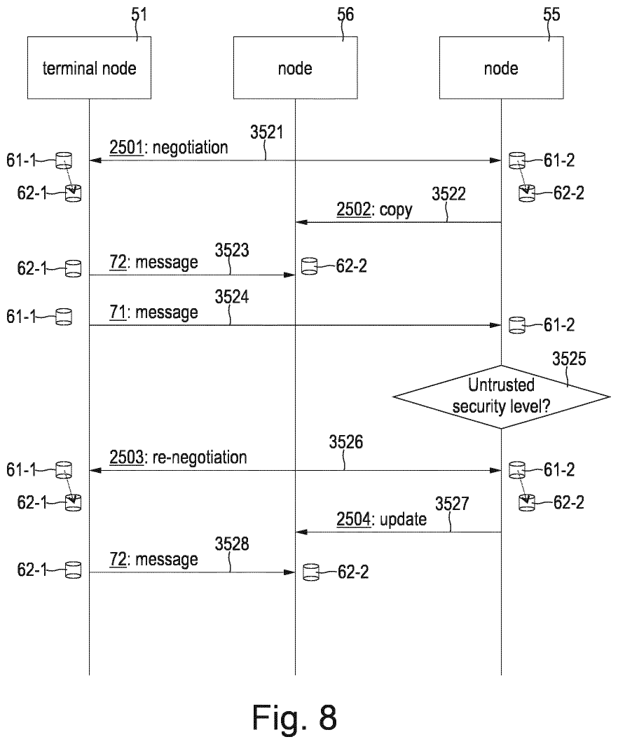

FIG. 8 is a signalling diagram schematically illustrating aspects with respect to cloning of a security context. The scenario of FIG. 8 generally corresponds to the scenario of FIG. 6.

Specifically, 3521 corresponds to 3511. 3522 corresponds to 3512. 3523 corresponds to 3514. 3524 corresponds to 3513.

Then, in the scenario of FIG. 8, an untrusted security level is detected when communicating using the first instance of the security context 61-2, at 3525. This triggers a re-negotiation of the first instance of the security context 61-2 which includes respective control signalling 2503 at 3526. Also, the terminal node 51 participates in the re-negotiation of the respective first instance of the security context 61-1. Then, also the second instance of the security context 62-2 is updated, at the terminal node 51 and the node 55 and a respective control message 2504 for providing the update of the second instance of the security context is transmitted by the node 55 and received by the node 56, at 3527. 3528 corresponds to 3519.

In the scenarios of FIGS. 1, 6-8, the nodes 55, 56, 57 may be part of the same trusted domain. The control signalling, e.g., 2502 and 2504 may be protected using E2EE between the respective nodes 55, 56, 57.

While in the scenarios of FIGS. 6-8 detection of the untrusted security level, at 3515, 3505, as well as 3525 has been illustrated with respect to the end nodes 55, 56, in other scenarios the untrusted security level may also be detected by the terminal node 51. Also in such a scenario, there may be different options for updating the respective instance of the security context; e.g., the master-slave scenario according to FIG. 6 or a peer scenario according to FIG. 7.

The techniques illustrated above can be applied in various use cases. Hereinafter, application of such techniques of cloning a security context are illustrated with respect to a specific use case. This specific use case relates to encrypting an NAS control message. Encryption of an NAS control message is exemplarily explained in connection with a 3GPP 5G NR architecture, but could likewise be applied in the 3GPP 4G LTE architecture.

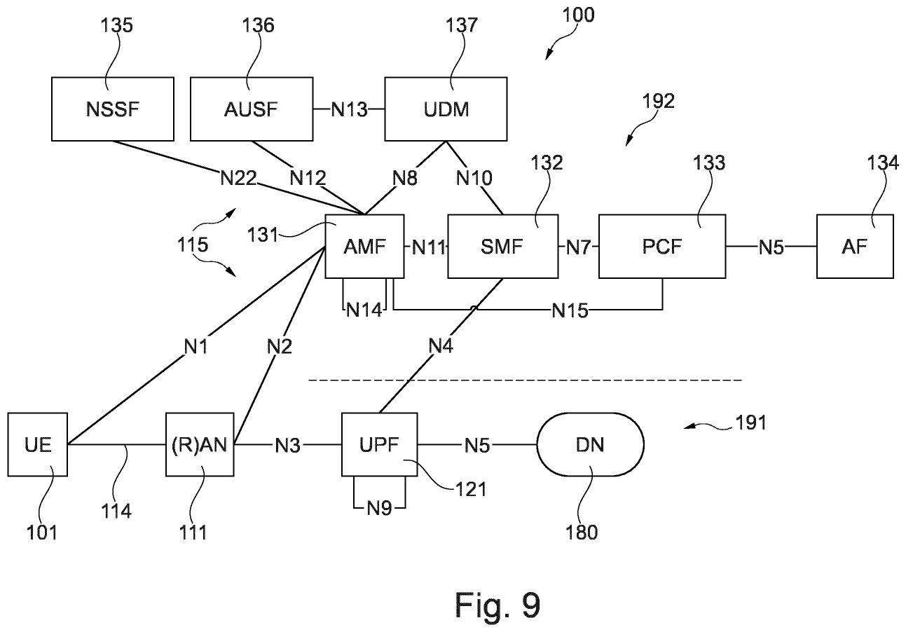

FIG. 9 schematically illustrates a network 100. The example of FIG. 9 illustrates the network 100 according to the 3GPP 5G architecture. Details of the fundamental architecture are described in 3GPP TS 23.501, version 1.3.0 (2017-09). While FIG. 9 and further parts of the following description illustrate techniques in the 3GPP 5G framework, similar techniques may be readily applied to different communication protocols. Examples include 3GPP LTE 4G and IEEE Wi-Fi technology.

In the scenario of FIG. 9, a UE 101 is connectable to the network 100. For example, the UE 101 may be one of the following: a cellular phone; a smart phone; and IOT device; a MTC device; a sensor; an actuator; etc. The UE 101 could implement the terminal node 51 according to FIGS. 1-8.

The UE 101 is connectable to the network 100 via a RAN 111, typically formed by one or more BSs (not illustrated in FIG. 1). A wireless link 114 is established between the RAN 111—specifically between one or more of the BSs of the RAN 111—and the UE 101.

The RAN 111 is connected to a CN 115. The CN 115 includes a UP 191 and a CP 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data network 180, e.g., the Internet or a Local Area Network. Application data can be communicated between the UE 101 and one or more servers on the data network 180.

The network 100 also includes an Access and Mobility Management Function (AMF) 131; a Session Management Function (SMF) 132; a Policy Control Function (PCF) 133; an Application Function (AF) 134; a Network Slice Selection Function (NSSF) 134; an Authentication Server Function (AUSF) 136; and a Unified Data Management (UDM) 137. FIG. 1 also illustrates the protocol reference points N1-N22 between these nodes.

In the various examples described herein, the AMF 131, as a CN mobility node, could implement the node 55 and the UPF—as a gateway node to the data network 180—and/or a BS of the RAN 111 could implement the nodes 56, 57. It would be possible that the node 56 or 57 is implemented by any node that terminates communication with the UE 101; e.g., the SMF 132.

The AMF 131 provides one or more of the following functionalities: registration management; NAS termination; connection management; reachability management; mobility management; access authentication; and access authorization the AMF 131 can negotiate an NAS-level security context with the UE 101. See 3GPP TS 23.501 version 1.3.0 (2017-09), section 6.2.1.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc.

As such, the AMF 131 and the SMF 132 both implement CP mobility aspects needed to support a moving UE.

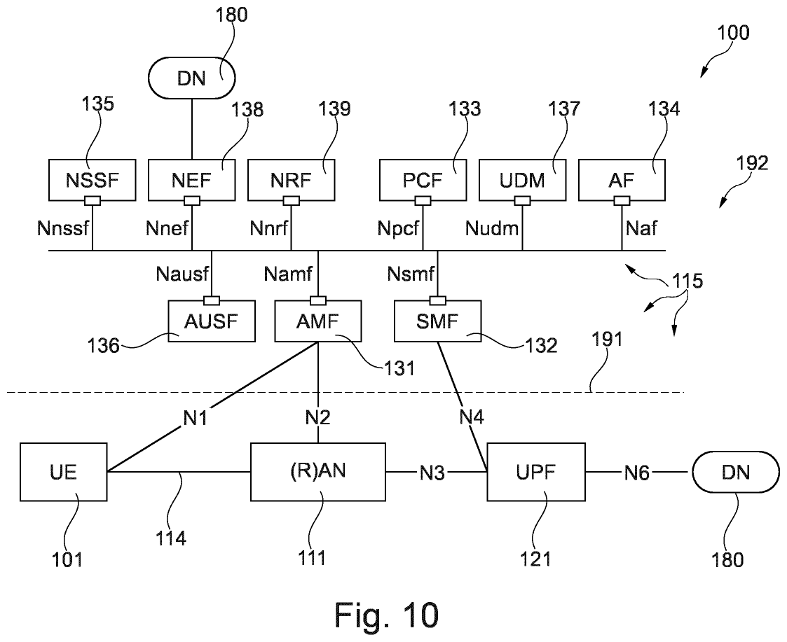

FIG. 10 schematically illustrates the network 100 according to FIG. 9 in greater detail and as a service-based architecture. In addition to the CP nodes already illustrated in connection with FIG. 9, FIG. 10 also illustrates the following CP nodes: the Network Exposure Function (NEF) 138 which provides functionality to expose services and capabilities provided by the network 100 to the further data network 180. For example, non-IP application data can be routed to the data network 180 via the NEF 138.

In the various examples described herein, the NEF 138—as a gateway node to the data network 180—could implement one of the nodes 55-57 according to FIGS. 1-8.

A further node illustrated in FIG. 10 is the NF Repository Function (NRF) 139.

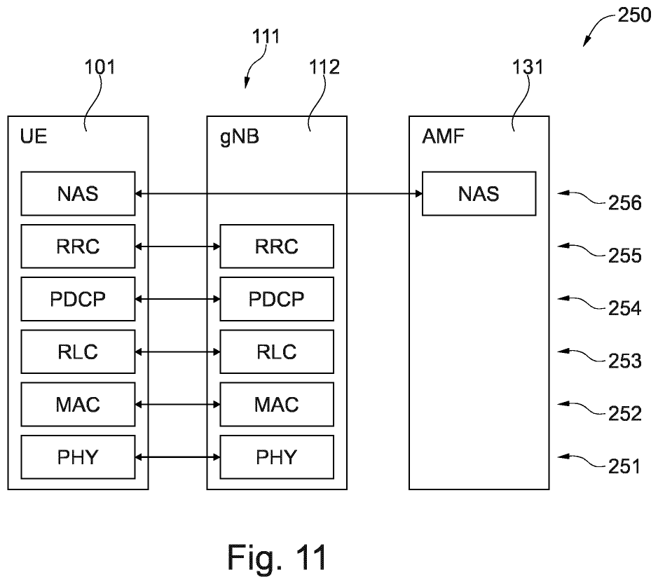

FIG. 11 illustrates aspects with respect to a transmission protocol stack 250 implemented for control signalling between the UE 101, a BS 112 of the RAN 111 (labelled gNB in FIG. 3, according to the 3GPP 5G terminology), and the AMF 131. Specifically, FIG. 11 schematically illustrates a control signalling transmission protocol stack 250.

The transmission protocol stack 250 includes a Layer 1 251, the so-called physical layer. The transmission protocol stack 250 also includes Layer 2 functionality provided by the Medium Access (MAC) layer 252 and the Radio Link Control (RLC) layer 253. The RLC layer 253 provides for one or more of the following functionalities: error correction using an Automatic Repeat Request (ARQ) protocol, segmentation and reordering of protocol data units, scheduling, etc. The MAC layer 252 provides for one or more of the following functionalities: control of access to the physical transmission medium, framed the limiting and recognition; etc.

Next, Layer 3 is implemented by the Packet Data Convergence Protocol (PDCP) layer 254 which provides one or more of the following functionalities: transfer of application data and control data; header compression such as robust header compression (RoHC); Access Stratum (AS) level security. Layer 3 is also implemented by the Radio Resource Control (RRC) layer 255 which provides for control signalling functionality between the UE 101 and the BS 112; also, additional Layer 3 functionalities are implemented by the NAS layer 256 which provides for control signalling functionality between the UE 101 and the AMF 131.

The RRC layer 255 provides one or more of the following functionalities: bearer establishment and release; paging notification; broadcasting of system information. Likewise, also the NAS layer 256 provides for functionality associated with one or more of the following, with respect to signalling towards the core network: bearer establishment and release; mobility control; identity management. The NAS layer 256 also provides for E2EEs, e.g., as discussed above with respect to FIG. 1. In some scenarios, in order to transparently forward any NAS control data via the BS 112, and RRC control message may include an information field which has the purpose of including NAS control data. Then, the BS 112 may be configured to route the NAS control data included in the respective information field to the AMF 131. The NAS control data may be encrypted using E2EE. The BS 112 would include and forward the information field in a 3GPP NG Application Protocol (NGAP) message. See 3GPP TS 38.413 V0.3.0 (2017-08).

It is possible to communicate control messages of the NAS layer 256 and/or the RRC layer 255 on a SRB. A SRB can be associated with certain UE context information such that communication of RRC and/or NAS control messages can be facilitated with limited control signalling overhead. A SRB is used during the RRC establishment in a random access procedure to established radio access bearers or RAN UP bearers. The SRB may also be used for control signalling while the UE 101 is operated in a connected state in which RAN UP bearers are established; here performing handover or reconfiguration or release of the RAN UP bearers may be handled by the SRB.

Not illustrated in FIG. 11 is an application layer (e.g., Layer 7), a presentation layer (e.g., Layer 6), a session layer (e.g., Layer 5), and a transport layer (e.g., Layer 4), all stacked upon Layer 3 implemented by the NAS layer 256 and the RRC layer 255.

In the various examples described herein, Layer 3 control messages may be used for piggybacking application data, e.g., originating from Layer 7. Specifically, RRC layer 255 control messages communicated on the wireless link 114 may be used for piggybacking the application data. To facilitate such piggybacking, the application data may in some scenarios be included in an NAS control message native to the NAS layer 256, the NAS control message, in turn, being included in a RRC control message native to the RRC layer 255. Again, it is possible that the NAS control message is encrypted using E2EE, e.g., as discussed above in connection with FIG. 1.

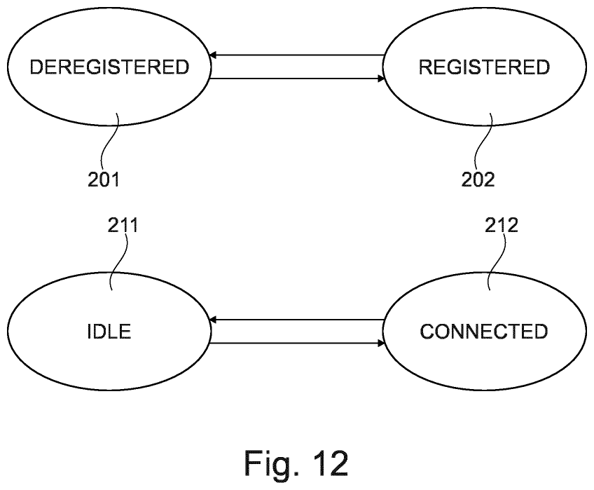

FIG. 12 illustrates aspects with respect to different states in which the UE 101 can be operated.

In the deregistered state 201, the UE 101 is not registered with the network. Here, the AMF 131 may not be aware of any valid locational routing information for the UE 101 so that the UE 101 may not be reachable. Some parts of context information associated with the UE 101 may be stored at the CN 115.

In order to transition from the deregistered state 201 to the registered state 202, the UE 101 can perform an initial registration procedure. In the registered state 202, the UE 101 is registered with the network 100. The UE 101 can then provide location updates in order to account for mobility. If a certain idle timer lapses or if the UE 101 sends a deregistration request, transition into the deregistered state 201 is possible.

FIG. 12 also illustrates aspects with respect to connection states 211, 212. These connection states 211, 212 may be applicable where the UE 101 is operated in the registered state 202. In the idle state 211, the UE may be reachable by AMF-triggered paging in accordance with paging occasions defined by a discontinuous reception cycle (DRX). A RAN UP bearer may not be established on the wireless link 114. Via paging and a subsequent random access (RACH) procedure and a RRC connection setup procedure, operation of the UE 101 may transition into the connected state 212. Here, a RAN UP bearer is established between the BS 112 and the UE 101 on the wireless link 114.

Generally, it is possible that multiple connection states such as the connection states 211, 212 are defined, e.g., connection states for the RAN 111 and further connection states for the CN 115. Sometimes, these states are referred to as ECM connected and disconnected (ECM idle) for the CN state, and RRC connected and disconnected (RRC_idle or RRC inactive) for the RAN state.

In the various examples described herein, it would be possible to transmit and/or receive (communicate) application data while the UE 101 is operated in idle state 211, at least for the RAN 111. Here, a UP RAN bearer may not be established on the wireless link 114.

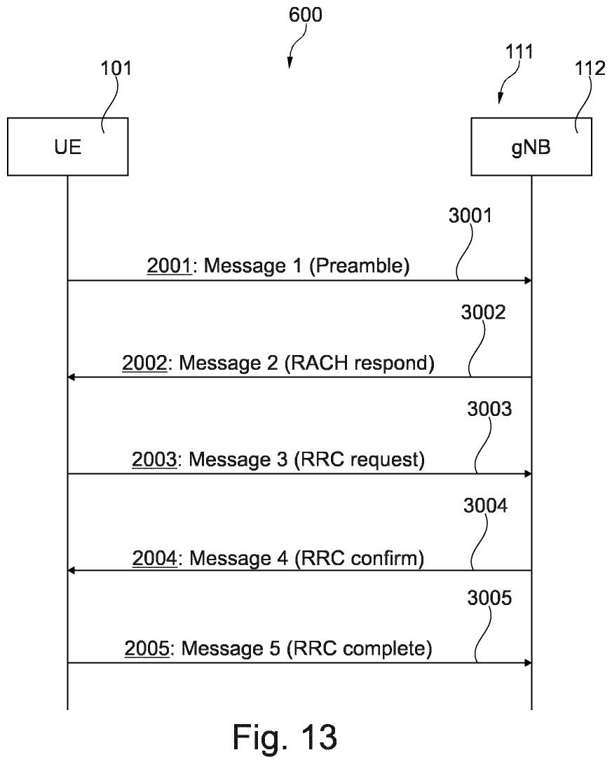

FIG. 13 illustrates aspects with respect to the RACH procedure 600 that may be used in order to transition from the idle state 211 to the connected state 212, or generally from another state to the connected state 212.

At 3001, the UE 101 transmits a RACH preamble 2001. This is sometimes also referred to as RACH message 1. The preamble may be randomly or at least partly randomly selected from a plurality of candidate preambles. The selected preamble helps to temporarily identify the UE 101 and distinguish the UE 101 from one or more other UEs that attempt connect to the network 100 via the BS 112 (contention). The BS 112 receives the RACH preamble 2001 and responds with a RACH response message 2002, 3002. The RACH response message 2002 may identify the RACH preamble 2001.

Next, at 3003, the UE 101 transmits a RRC request message 2003, sometimes also referred to as message 3. This is a RRC control message. The RRC request message 2003 serves the purpose of setting up a RAN UP bearer between the UE 101 and the BS 112. The size of message 3 is limited, but still it is possible to piggyback application data to this control message 2003. The application data may be encrypted using E2EE, e.g., on NAS layer. At this point, operation of the UE 101 has not fully transitioned into the connected state 212 (cf. FIG. 4). The RRC request message 2003 may be already associated with a SRB.

Then, at 3004, the BS 112 response with a RRC connection setup message 2004, sometimes also referred to as RACH message 4. The RRC connection setup message 2004 includes configuration information and confirms/acknowledges the request in message 3.

Then at 3005, the UE 101 transmits a RRC connection setup complete control message 2005, sometimes also referred to as message 5. The RRC connection setup compete message confirms that the connection is fully established. At the point, the UE 101 may have transitioned into operation in the connected state 212 (cf. FIG. 4).

It would be possible to piggyback application data to this control message 2005. The application data may be encrypted using E2EE, e.g., on NAS layer.

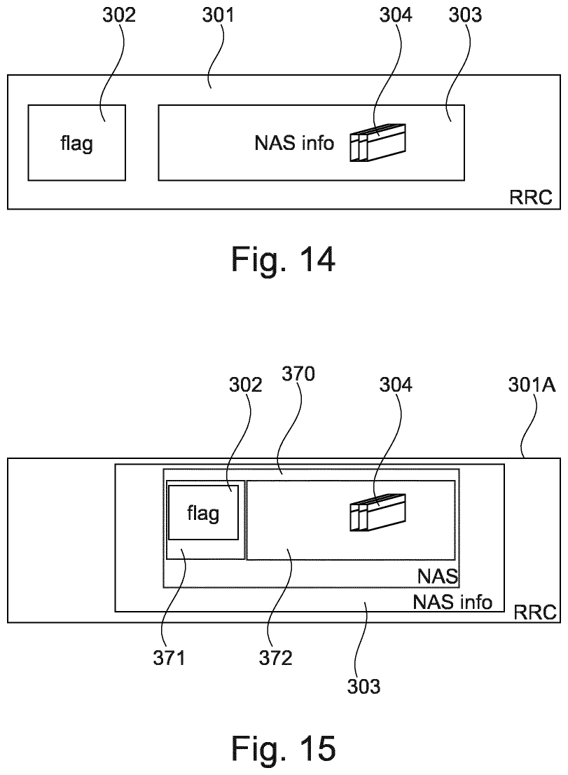

FIG. 14 schematically illustrates aspects with respect to a control message 301 that can be used for communicating application data 304 between the UE 101 and the BS 112. In the example of FIG. 14, the control message 301 is a RRC control message, i.e., native to the RRC layer 255 (cf. FIG. 11).

The RRC control message 301 could be implemented, according to some examples, by the RRC request message 2003 of the RACH procedure 600 (cf. FIG. 13). However, in other examples, the RRC control message 301 could be implemented by other messages, e.g., an RRC control message transmitted after block 3004 of FIG. 13 such as the RRC complete control message 2005. For example, the RRC control message 301 could be communicated on a SRB.

The RRC control message 301 includes an information field 303. The information field is associated with NAS control data, i.e., is an NAS information field 303. The content of the NAS informational field 303 may be encrypted using NAS-level E2EE. For this, a respective security context may be provisioned at the UE 101. The NAS information field 303 may include an NAS control message or, generally, any NAS-layer data. Thus, the NAS information field 303 and, optionally, the NAS control message, is piggybacked to the RRC control message 301. The information field is typically used for encapsulating NAS control data, e.g., as part of an NAS control message. As such, the content of the information field 303 is normally directed to the AMF 131. However, in the scenario FIG. 14, the information field 303 is re-used for piggybacking the application data 304 to the RRC control message 301. The application data 304 does not originate from the NAS layer 256, but from a higher layer. For example, the application data 304 may be included in an NAS control message included in the information field 303 or may otherwise be encapsulated in the information field 303.

Thus, a situation is encountered in which—depending on the particular instance of the RRC control message 301—either application data or NAS control data is included in the information field 303.

The application data 304 may be IP data, i.e., an IP packet including an IP header which may specify an address of a server of the data network 180. Alternatively, it would be possible that the application data 304 is non-IP data. Generally, the data 304 may be directed to a server of the data network 180.

The RRC control message 301 also includes an indicator 302. For example, the indicator 302 may be included in a header of the RRC control message 301—and hence at a higher hierarchy if compared to the information field 303—or may be included as a peer to the information field 303, i.e., at the same hierarchy. For example, the indicator 302 may be included in another information field of the RRC control message 301, different from the information field 303. In some examples (not illustrated in FIG. 14), it would even be possible that the indicator 302 is included in the information field 303. Generally, the indicator 302 may be included at a position of the control message 301 which is associated with the RRC layer 255. Then detection of the value of the indicator may be RRC-layer functionality of the RRC layer 255.

In the example of FIG. 14, the indicator 302 is implemented as a one-bit flag. Hence, the value of the indicator 302 may be either “1”/TRUE or “0”/FALSE. In other examples, other types of indicators may be used, e.g., multi-bit indicators.

Based on the indicator 302, it is possible to distinguish between the information field 303 including NAS control data; and the information field 303 including application data 304 (as illustrated in the scenario FIG. 14). Therefore, the indicator 302 facilitates routing of the content of the information field 303.

As will be appreciated, depending on the value of the indicator 302, the destination of the content of the information field 303 differs, i.e., in one instance the AMF 131 and in a further instance the data network 180. Depending on the value of the indicator 302 of the respective instance of the RRC control message 301, the content of the information field 303, e.g., the NAS control message, can be routed differently.

In the example of FIG. 14, a scenario is illustrated in which detection of the value of the indicator may be RRC-layer functionality; this is because the indicator 302 is included in a header of the RRC control message 301. However, other scenarios are possible. Specifically, it would be possible that the detection of the value of the indicator 302 is NAS layer functionality. Such a scenario is illustrated in connection with FIG. 15.

FIG. 15 schematically illustrates aspects with respect to a control message 301A that can be used for communicating application data 304 between the UE 101 and the BS 112. In the example of FIG. 15, the control message 301A is a RRC control message, i.e., native to the RRC layer 255 (cf. FIG. 11).

Generally, the scenario of FIG. 15 corresponds to the scenario of FIG. 14. However, in the scenario of FIG. 15, the indicator 302 is included in the NAS information field 303.

Generally, there are various options available for including the indicator 302 in the NAS information field. The particular scenario of FIG. 15 is an example in which the information field 303 includes an NAS control message 370. The NAS control message 370, in turn, includes a header section 371 and a payload section 372. Here, the indicator 302 is included in the header section 371; while the application data is included in the payload section 372. It should be appreciated that not all fields in the header section 371 will be NAS-layer encoded—e.g., encrypted—and the indicator 302 may be one of the fields that are not encoded. From FIG. 15 in combination with FIG. 11, it will be appreciated that the control messages 301A and 370 are native to different layers of the transmission protocol stack 250, i.e., the RRC layer 255 for control message 301A and the NAS layer 256 for the control message 370.

In scenarios in which the indicator 302 is included in the information field 303, detection of the value of the indicator may be NAS-layer proxy functionality (if compared to the RRC-layer functionality according to the example of FIG. 14). This has the advantage that lower layers—including RRC layer—may operate according to legacy functionality.

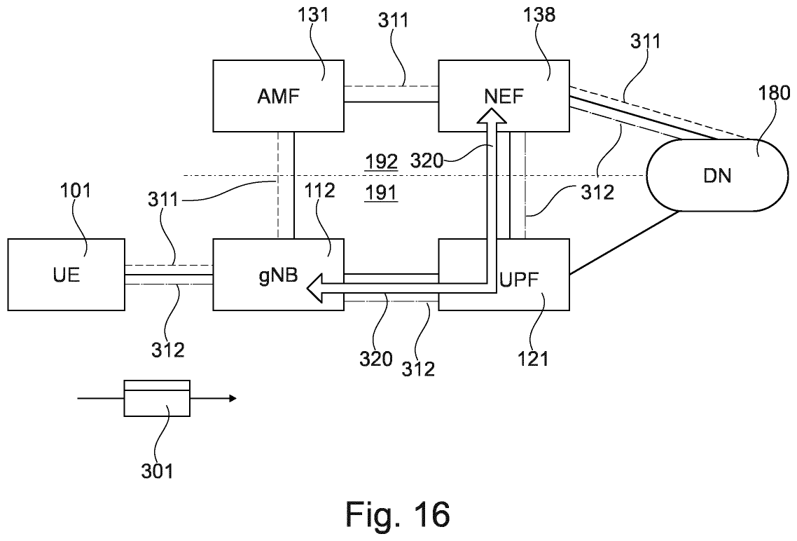

In the various examples described herein, it is possible to flexibly arrange the indicator 302 with the control message 301, 301A. Irrespective of the particular position of the indicator 302 within the control message 301, 301A, it is possible to route the content of the information field 303 along different paths taking into account the value of the indicator 302. Thereby, switch-point functionality may be implemented based on the value of the indicator 302. Likewise, different instances of a security context may be selected based on the value of the indicator. Respective techniques are described in FIG. 16.

According to various scenarios described herein—such as the scenarios of FIGS. 14 and 15—, it is possible to employ a different instance of a security context of respective E2EEs depending on the value of the indicator 302. For example, the NAS control message 370 included in the information field 303 may be encrypted based on a first instance of a security context of a first E2EE or based on a second instance of the security context of a second E2EE. Specifically, in the illustrated scenario, the NAS control message may be encrypted, by the UE 101, using a first instance of a security context when routed to the AMF 131 or may be encrypted, by the UE 101, using a second instance of the security context when routed via the UP. If NAS control data originating from Layer 3 is included in the NAS control message 370, then, the first instance of the security context can be selected; if, however, application-layer data is included in the NAS control message 370, then the second instance of the security context can be selected for encryption. As a general rule, it is possible to select between different instances of the security context based on an originating transmission protocol layer of payload of the respective instance of the message, when encrypting.

Then, depending on the particular instance of the NAS control message included in the information field 303, a different instance of a NAS-level security context may be used for encrypting the respective instance of the NAS control message. The value of the indicator 302 can be set accordingly.

Likewise, when decrypting, it is possible to select between different instances of the security context depending on the value of the indicator; the value of the indicator correlates with the selected instance of the security context. For example, it would be possible to receive, at the UE 101, a first instance of the NAS control message 370 with the indicator 302 having a first value when communicating with the first node such as the AMF 131 and decrypting a first instance of the message based on the first instance of the security context. When receiving, at the UE 101, a second instance of the message with the indicator 302 having a second value different from the first value when communicating with a second node—such as the BS 112, the UPF 121, or the NEF 138—, the second instance of the NAS control message can be decrypted based on the second instance of the security context.

It is possible to obtain the first instance of the security context and the second instance of the security context from cloning (cf. FIG. 1). This relieves the UE 101 from the task of having to separately negotiate different security contexts with the AMF 131 and another node such as the BS 112 or the UPF 121 or the NEF 138 for application-layer data.

FIG. 16 schematically illustrates aspects with respect to routing of the content of the information field 303. In the scenario FIG. 16, the content of the information field 303 is routed by the BS 112. Hence, the BS 112 implements switch-point functionality. When routing the content of the information field 303, the BS 112 takes into account the value of the indicator 302 of the RRC control message 301.

Illustrated in FIG. 16 is a scenario in which the BS 112 receives the RRC control message 301 from the UE 101. In another scenario, the BS 112 transmits the RRC control message 301 to the UE 101.

In a reference implementation, the BS 112 would route the information field 303 including the application data 304 along a path 311 (dashed line in FIG. 16). In detail, in such a reference implementation, the BS 112 would forward the content as part of the information field 303 to the AMF 131. The AMF 131 could then decrypt the application data, e.g., could decrypt the information field 303 including the application data based on a security context of the NAS-level UE-AMF E2EE. Then, the AMF 131 would identify that the decrypted content of the information field 303 corresponds to application data 304—and not to NAS control data. Specifically, the AMF 131 may identify that the content of the information field 303 corresponds to non-IP application data; then, the AMF 131 would forward the non-IP application data to the NEF 138 which, in turn, would forward the non-IP application data 304 to the data network 180.

As will be appreciated from FIG. 16, the path 311 according to the reference implementation extends through the CP 192. Specifically, the AMF 131 is burdened with the task of proxying the application data 304. This may increase latency and cause congestion at the AMF 131. Further CP-UP separation is breached to some extent, because the application data passes through the AMF 131 as a CP 191 node.

According to techniques described herein, it is possible to route the application data 304 via the UPF 121; the AMF 131 is circumvented. This relieves the AMF 131 from the task of proxying the application data 304 or, generally, performing data over NAS functionality. For example, the AMF is not required to perform decryption. According to examples, it is possible to selectively route the data 304 for via the UPF 121 to the NEF 138, depending on the value of the indicator 302. Thus, the value of the indicator 302 may change for different instances of the respective message 301, 301A. Then, along with the different routes, the content of the information field 303 can be encrypted using different instances of a security context This is explained in greater detail hereinafter:

For example, if the indicator 302 takes a first value in a first instance of the message 301, 301A, this may be indicative of the content of the information field 303 corresponding to NAS control data. Then, the content of the information field 303—i.e., the NAS control data—may be encrypted by the UE 101 with a first instance of the security context of NAS-level E2EE and may be routed to the AMF 131 for further processing of the NAS control data. This corresponds to routing via the CP. Differently, if the indicator 302 takes a second value in a second instance of the message 301, 301A, this may be indicative of the content of the information field 303 corresponding to application data 304. Then, the content of the information field 303—i.e., the application data—may be encrypted by the UE 101 with a second instance of the security context of NAS level E2EE and may be routed to the UPF 121. This corresponds to routing via the UP. Thus, selectively routing the data via the UPF 121 may correspond to: routing or not routing the data via the UPF 121, depending on the value of the indicator 302. The content of the control message 301 e.g., the information field 303 is selectively routed via the CN CP or the CN UP, depending on the value of the indicator.

As will be appreciated, the message 301 can be encrypted based on different instances of the security context, correlating with the value of the indicator 302. It would be possible that the security context is initially negotiated between the UE 101 and the AMF 131; and then cloned to the respective node performing proxy functionality—including encrypting and decrypting—when routing via the UP, e.g., the BS 112, the UPF 121, or the NEF 138. Hence, a scenario according to FIG. 6 could be implemented where the AMF 131 implements the master node 55 and the BS 112 and/or the UPF 121 and/or the AMF 138 implements the slave node 56 and the UE 101 implements the terminal node 51.

Hence, the indicator facilitates situation-aware encrypting and decrypting of the data encapsulated in the information field 303. Also, the indicator facilitates situation-aware routing of the data encapsulated in the information field 303. By the situation-aware encrypting/decrypting and routing of the data encapsulated in the information field 303, the processing load imposed to the AMF 131 can be lowered.

While in the scenario of FIG. 16 the application data 304 is routed through the NEF 138 implementing a gateway node towards the data network 180 for non-IP application data 304, in other scenarios it would be possible that the application data 304 is routed through a UPF 121 implementing the gateway node towards the data network 180 for IP application data. Thus, a further selective routing may be implemented depending on whether the application data is IP data or non-IP data.

FIG. 16 also illustrates aspects with respect to a CN UP bearer 320. For routing of the application data 304, generally, a UP bearer 320 may be employed. Specifically, a CN UP bearer may be employed: the UE 101 may not be aware of the CN UP bearer 320, because it does not extend to the UE 101. The UP bearer 320 may be set up by the SMF 132 in response to the RRC request message 2003. A characteristic of the UP bearer 320 is that it encompasses one or more UPFs 121. An endpoint of the UP bearer 320 is the BS 112; a further endpoint of the UP bearer 320 as the NEF 138—this is because in the illustrated scenario non-IP application data is encapsulated in the information field 303. For IP application data, the UPF 121 could implement the endpoint of the UP bearer 320 instead of the NEF 138.

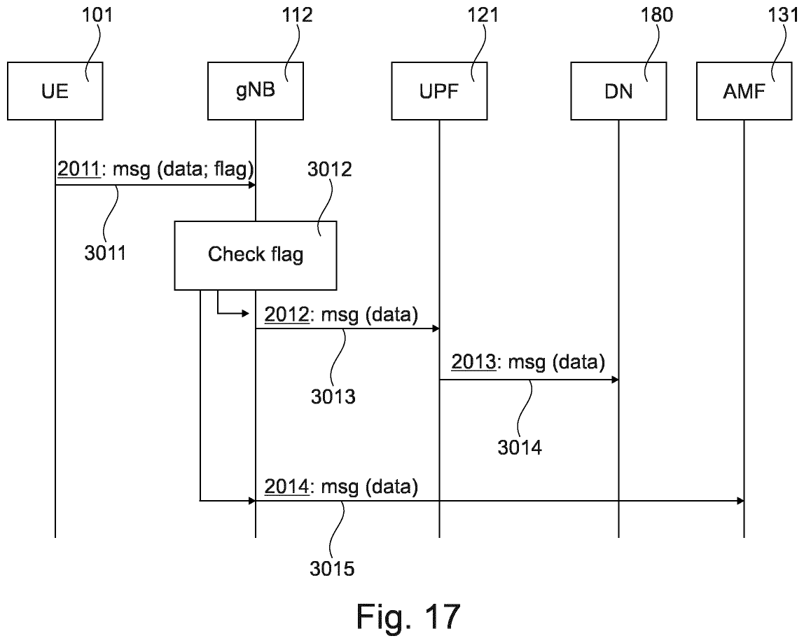

FIG. 17 is a signalling diagram illustrating aspects with respect to routing data included in the information field 303 of the RRC control message 301. At 3011, a control message 2011 is transmitted by the UE 101 and received by the BS 112. For example, the control message 2011 may be a RRC control message. The control message 2011 may be communicated on an SRB. The control message 2011 may include a UE identity. For example, the control message 2011 could be the control message 301 according to the example of FIG. 14 or the control message 301A according to the example of FIG. 15.

The control message 2011 includes the flag 302 and the information field 303 which encapsulates data. The flag 302 is indicative of whether the information field 303 encapsulates control data or application data, e.g., IP application data or non-IP application data. The flag 302 is also indicative of the particular instance of a security context of E2EE applied to encrypt the content of the control message 2011.

In more complex scenarios, an indicator included in the control message 2011 may be indicative of further details of the application data, e.g., it's type such as IP application data or non-IP application data, QoS level, application service code, priority, size, destination, etc.

Accordingly, the BS 112, at 3012, checks the value of the indicator 302 and, depending on the value of the indicator, at 3013 either routes the data in a corresponding message 2012 to the UPF 121 implementing a UP node; or at 3015 routes the data in a corresponding message 2014 to the AMF 131 implementing a CP mobility node.

The UPF 121 provides the data in a corresponding message 2013 to the data network 180. The UPF 121, in the example of FIG. 7, implements gateway functionality and, hence, acts as a gateway node. Instead of the UPF 121, another gateway node may be generally used, e.g., the NEF 138.

In the scenario of FIG. 17, the BS 112 and/or the UPF 121 may perform decryption of a content of the control message using a respective instance of a security context; the AMF 131 may perform decryption of a content of the control message 2014 using a further instance of the security context of the E2EE.

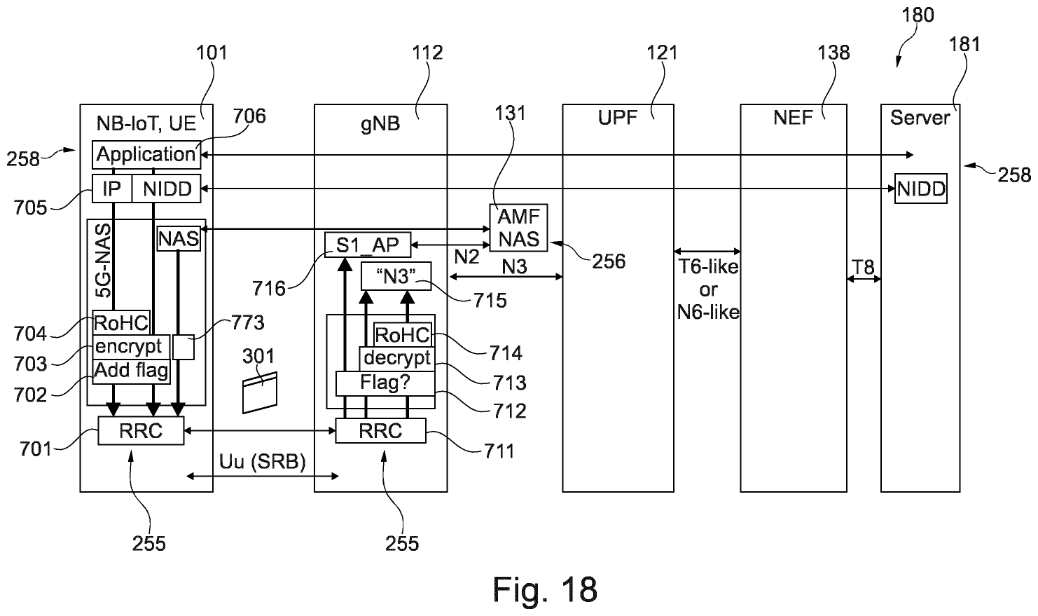

FIG. 18 illustrates aspects with respect to the logic implemented by the various nodes 101, 112, 121, 138, 181 to facilitate such situation-aware routing of data encapsulated in a control message discussed with respect to the various FIGs. herein.

FIG. 18 is structured according to the transmission protocol stack 250 discussed in connection with FIG. 11; as such, logic functionality depicted higher (lower) in FIG. 18 corresponds to higher (lower) layers. In the scenario of FIG. 18, an application layer 258 (layer 7) provides, at 706, IP application data or non-IP application data to the RRC layer 255, block 701. Here, an IP header may be added, e.g., including a 5-tuple with source and destination address. In case of non-IP application data some other way is used to address the destination. This differentiation between IP application data and non-IP application data is made at 705.

The application data is queued for transmission via the wireless link 114.

The UE 101 implements logic for robust header compression (RoHC) 704 of a header of IP packets, if IP application data is provided by the application layer 258. For non-IP application data, RoHC may be omitted. Generally, reformatting of the header may be performed, which reformatting may include the RoHC or other techniques. RoHC 704 is optional.

At block 703, encryption of the application data received from the application layer 258 is performed. For example, a first instance of an NAS security context may be used.

At block 702, the UE 101 is configured to set the value of the indicator 302 depending on the layer from which the data originates. Specifically, in the scenario of FIG. 18, the UE 101 is configured to set the value of the indicator 302 such that it reflects encapsulation of the application data in the RRC control message 301. Generally, the value of the indicator 302 is set at the UE 101 depending on whether the data is control data for the AMF 131 or application data directed to a server 181 of the data network 180. Further decision criteria can be taken into account, e.g., a type of the data, a quality of service associated with the data, etc.

If NAS control data is communicated by the NAS layer 256, the value of the indicator 302 is set appropriately, as illustrated in FIG. 18. Thus, the value of the indicator 302 is generally selected depending on a type of the data to be included in the control message and/or the layer from which the data originates. Also, a second instance of the NAS security context may be used, block 773 the second instance may generally be at least partially different from the first instance. For example, the UE may maintain two separate counters for the two instances thereby accommodating for different values of the respective dynamic parameter.

In the scenario of FIG. 18, the RRC control message 301 is then communicated using the RRC layer 255. The RRC control message 301 is transmitted by the UE 101 and received by the BS 102. This may involve Layer 1 and Layer 2 support.

At block 712, the BS 112 checks the value of the indicator 302, block 712. Depending on the value, the data encapsulated in the information field 303 is either transparently forwarded to the NAS layer 256 in the AMF 131 by forwarding along the N2 reference point to the AMF 131, because the gNB 112 may not be in possession of the second instance of the NAS security context (cf. FIG. 9); or proxy functionality—generally associated with data over NAS functionality—is performed at blocks 713, 714 and the application data 304 is forwarded to UPF via N3.

Various options are available for implementing the proxy functionality. The proxy functionality may include cryptographic functionality including encryption and/or decryption—in other scenarios it would also be possible that cryptographic functionality is separate from the proxy functionality.

Alternatively or additionally, the proxy functionality may include header compression—in particular, when header compressing was performed at the UE 101, then, subsequently decompressing the header at the BS 102 at block 714 may be performed.

Once the proxy functionality has been performed, the application data 304 is routed to the UPF 121 and subsequently to the NEF 138 and finally provided to the server 181 in the data network 180. This is along the N3 reference point, T6 reference point, and T8 reference point. T6 and T8 reference points may be used in 3GPP LTE 4G framework which is illustrated as an example in FIG. 18; alternative and modification to T6 and T8 are possible.

While in FIG. 18 a scenario of UL data has been illustrated, in other examples DL data may be communicated. Here, the BS 112 or another node may perform the proxy functionality 714, 713 for the DL data and may optionally set the value of the indicator. For example, it would be possible that the UPF 121 or the NEF 138 perform the proxy functionality for DL data received from the data network 180 (not illustrated in FIG. 18). Then, the UE 101 may select the appropriate instance of the security context of the E2EE depending on the value of the indicator.

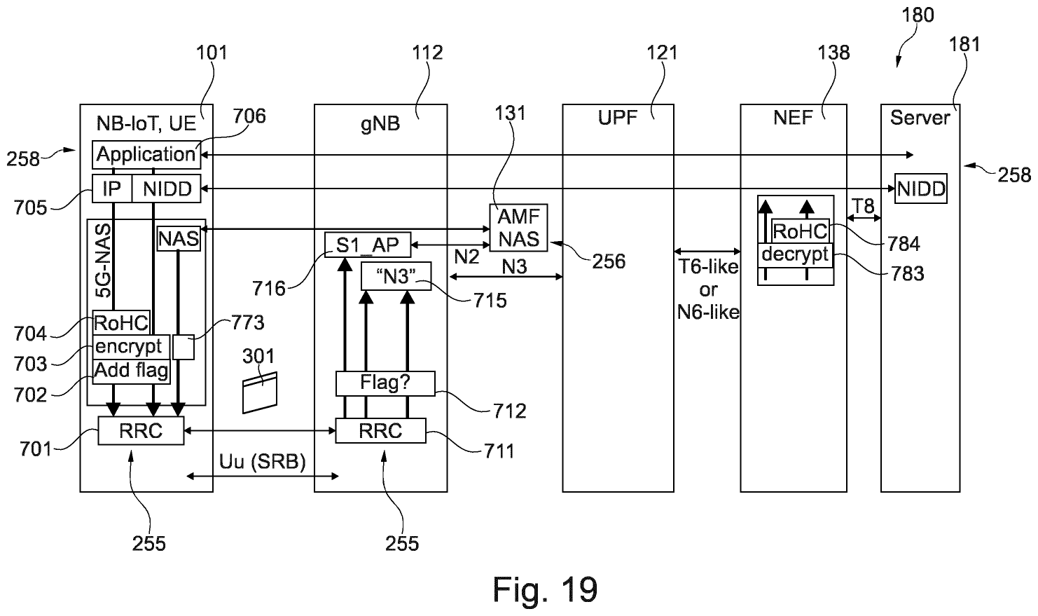

With respect to FIG. 18, a scenario has been illustrated in which the proxy functionality, at blocks 713 and 714, is implemented at the BS 112. In other examples, it would be possible that the proxy functionality—i.e., header compression functionality and/or cryptographic functionality—is implemented by the UPF 121, the NEF 138, or generally a gateway node of the network 100 to the data network 180. In such a scenario, the BS 112 may transparently forward, based on the indicator 302, the content of the information field 303 and is relieved of the task of performing the proxy functionality. Such a scenario is illustrated in FIG. 19.

FIG. 19 illustrates aspects with respect to the logic implemented by the various nodes 101, 112, 121, 138, 181 to facilitate situation-aware routing of data encapsulated in the control message discussed with respect to the various FIGs. herein. The scenario of FIG. 19 generally corresponds to the scenario according to FIG. 18.

Specifically, in FIG. 19, the implementation at the UE 101 corresponds to the implementation at the UE 101 in the scenario according to FIG. 18. In contrast to the scenario of FIG. 18, in the scenario of FIG. 19, the GNB 112 does not implement proxy functionality. Specifically, the BS 112 does not perform robust header compression and cryptographic functionality. Such functionality is rather implemented at the NEF 131 which, at block 783, performs cryptographic functionality including decrypting of the content of the control message 301 and, at block 784, performs robust header compression functionality which is, again, optional. For performing the cryptographic functionality at block 783, the NEF 138 is in possession of the respective first instance of the NAS security context. Again, it would be possible that the NEF 138 obtains the respective first instance of the NAS security context from the AMF 131, e.g., in a master-slave scenario according to the example of FIG. 6.

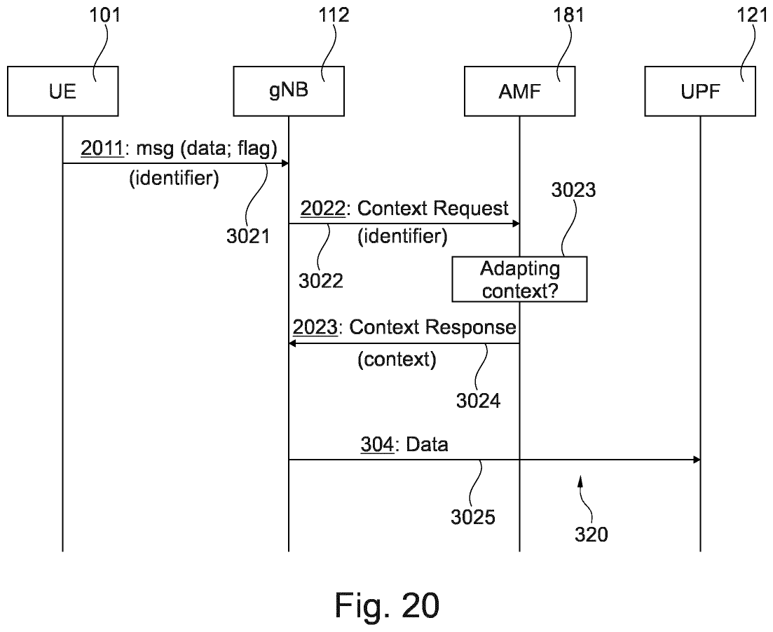

Above, various techniques have been described which facilitate CN routing of application data. As described above, it is possible to employ a CN UP bearer 320 for said routing in the CN. Details with respect to said CN routing are described in connection with FIG. 20.

FIG. 20 illustrates aspects with respect to routing application data. FIG. 20 is a signalling diagram. FIG. 20 illustrates aspects in connection with routing the application data using a CN UP bearer.

At 3021, the message 2011 is transmitted by the UE 101 and received by the BS 112. The message 2011 includes the indicator 302 and the information field 303. UL application data 304 is encapsulated in the information field 303. For example, the message 2011 may correspond to the message 301 of FIG. 14 or message 301A of FIG. 15. For example, the message 2011 may be implemented by the RRC request message 2003 or the RRC complete message 2005 of the RACH procedure 600 (cf. FIG. 13).

In the scenario of FIG. 20, the message 2011 also includes an identifier of the UE 101. Generally, the identifier of the UE 101 may be provided to the BS 112 as part of the message 2011 or separately from the message 2011, e.g., in a separate control message. The identifier is uniquely allocated to the UE 101; hence, there are no further UEs in the network 100 having the same identifier. For example, an identifier may be used which, in addition to identifying the UE 101, also identifies the AMF 131 to which the UE 101 is registered. For example, it would be possible to use the Globally Unique Temporary Identity (GUTI) according to the 3GPP TS 23.003, version 15.0.0 (2017-06), section 2.8; or a shortened/abbreviated version of the GUTI e.g., S-TMSI. In particular, it may be possible to use a CN identifier, i.e., an identifier which is created by a CN node such as the AMF 131. For example, a CN identifier may be used that also allows to route control messages of control signalling between the UE 101 and the AMF 131 to the correct AMF 131. In other examples, it would also be possible to use a RAN identifier, e.g., created by the RAN 111.

Then, based on the identifier, the BS 112 can establish/find the context information for the CN UP bearer 320. It would be possible that the UP bearer 320 has been previously set up, i.e., is ready-to-use when receiving the control message 2011. For employing the UP bearer 320—which may be uniquely allocated to data originating from or being directed to the UE 101—the context information may be required. Based on the context information, it is hence possible to route application data 304 piggybacked to the control message 2011 along the CN UP bearer 320. The application data can be forwarded along CN UP bearer 320 as a standalone packet or included in the Information field/NAS message 303.

The context information for the UP bearer 320 may be reserved for use by the UE 101. As such, the context information is sometimes referred to as context information of the UE 101.

In the various scenarios described herein, different options are available for establishing, i.e., finding, this context information to be used in connection with routing the application data 304 along the CN UP bearer 320. In a first option, it would be possible that the context information has been previously received by the BS 112, e.g., from the AMF 131. Then, the BS 112 may store the context information on the local memory and may load the context information from the local memory in response to receiving the control message 2011. Specifically, the context information may be linked with the identifier uniquely allocated to the UE 101; then, by receiving the identifier from the UE 101 at 3021, it is possible to load the correct context information from the local memory based on the identifier. Hence, establishing the context information may correspond to loading the context information from the local memory.

Another option for establishing the context information is illustrated in connection with FIG. 20. This option involves retrieving the context information from the AMF 131. Specifically, in response to receiving the control message 2011, the BS 112 transmits a context request message 2022 to the AMF 131. The context request message 2022 may also be referred to as routing request, because it facilitates routing of the application data. The AMF 131 receives the context request message 2022. The context request message also includes the identifier uniquely allocated to the UE 101. The AMF 131 may locally store or at least be able to retrieve the context information based on the identifier. In this option, establishing the context information may correspond to communicating the context request message 2022.

Typically, the context information is also associated with the endpoints of the CN UP bearer 320. It would be possible that the BS 112 from which the context request 2022 is received at 3022 at the AMF 131 is not registered as an endpoint of the CN UP bearer 320. This may occur, e.g., if UE mobility has occurred between set up of the CN UP bearer 320 and communication of the payload data 304 piggybacked to the control message 2011 at 3021. Then, the context request message 2022 is received from a further BS if compared to the BS for which the context information of the CN UP bearer 320 has been previously set up, because the serving BS of the UE 101 has changed. If the BS 112 from which the context request 2022 is received at 3022 is not registered as an endpoint of the CN UP bearer 320, the AMF 131, at 3023, may adapt the context information accordingly. Specifically, the context information may be adapted such that it correctly reflects the up-to-date BS 112 is an endpoint of the UP bearer 320. Hence, it would be possible that the BS 112 via which the UE 101 attempts to connect is set as an endpoint of the CN UP bearer 320 by adapting the context information accordingly, sometimes referred to as path switch, e.g., of the respective N3 tunnel.

Irrespective of whether the context information has been adapted at 3023 or not, at 3024 the AMF 131 transmits a context response message 2023; hence, the context response message 2023 is transmitted in response to receiving of the context request message 2022. The context response message 2023 is received by the BS 112. The context response message 2023 includes the context information. Again, the context information may be associated with the identifier of the UE 101, such that the BS 112, based on knowledge of the identifier, may then link the context information included in the context response message 2023 to the UE 101. The context response message 2023 may or may not include the identifier uniquely allocated to the UE 101.

Then, at 3025, the application data 304 is transmitted by the BS 112 and received by the UPF 121. The application data 304, at 3025, is transmitted using the context information along the CN UP bearer 320.

In the scenario of FIG. 20, the context request message 2022 is triggered by the control message 2011 which already includes the application data 304 piggybacked thereto. Generally, the context request message 2022 may be transmitted in response to one or more trigger criteria. For example, generally, the context request message 2022 may be triggered by a RACH procedure 600 of the UE 101 at the BS 112. As explained above, it is possible that the control message 2011 including the application data 304 is, itself, part of the RACH procedure 600.

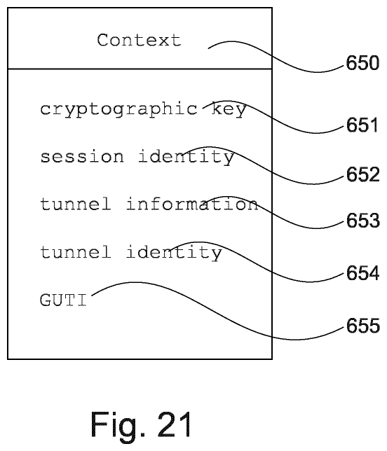

FIG. 21 illustrates aspects with respect to the context information 650. The context information may include one or more of the following: a cryptographic key 651; Security Context 60, a session identity 652; a tunnel information 653; and a tunnel identity 654. The cryptographic key 651 may be different from another security context of an E2EE, e.g., an NAS layer.

In the scenario FIG. 21, the context information 650 also includes an identifier 655 of the UE 101, specifically, the GUTI. In other examples, it would be possible that the identifier of the UE 101 is a separate data structure if compared to the context information 650, but in some manner linked to the context information 650 or associated therewith. In some examples, it would be possible that the context information 650 includes the GUTI in order to reliable identify the correct context information from a plurality of candidate context information 650. Thus, the GUTI may help to load the correct context information. It would be possible that the context information includes one or more further identities for routing data. Such example identities are described, e.g., in 3GPP TS 38.413 V0.3.0 (2017-08), Section 9.3.3. In further examples, it would be possible that the context information is associated with the AMF UE NGAP identity meaning that the UE identity, in message 2011, points to the context in the RAN node and the AMF UE NGAP identity in the context information points to the AMF end-point for the particular UE. See 3GPP TS 38.413 V0.3.0 (2017-08), Section 9. The two above identification options could be referred to as explicit identification and implicit identification. Generally, implicit identification or explicit identification of the UE is possible in connection with the context information 650 and the various examples described herein.

Typically, context information 650 regarding the CN UP bearer 320 is provided to the endpoints of the UP bearer 320, as well as, potentially, at least in parts at intermediate nodes—e.g. the UPF 121—along the path of the CN UP bearer 320. Creation and provisioning of the context information 650, e.g., at the BS 112, at the UPF 121, and/or the NEF 138, may be performed by the AMF 131 and/or the SMF 132 as CP mobility nodes.

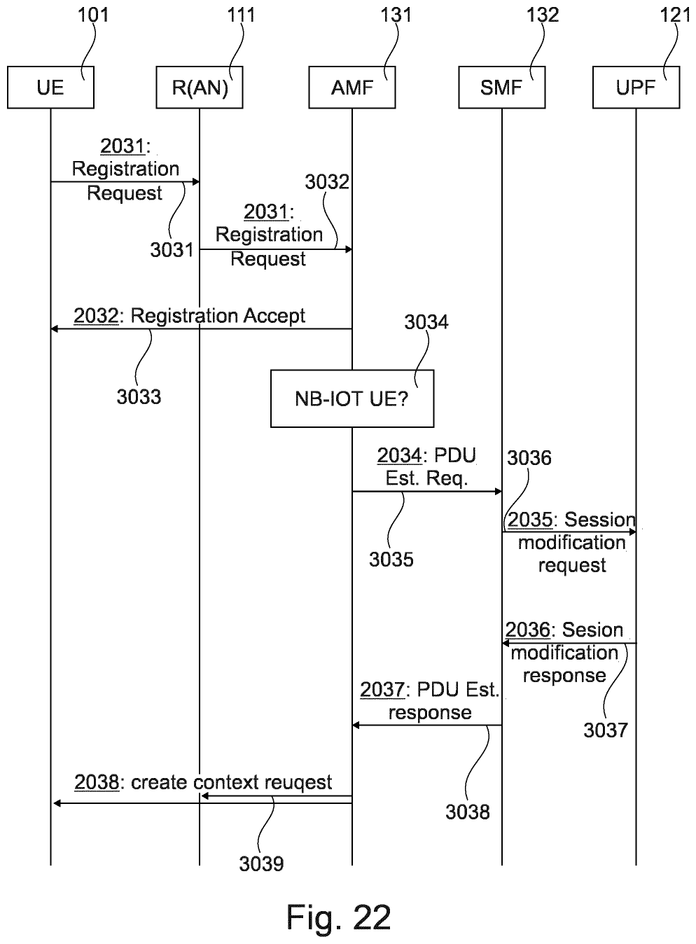

FIG. 22 illustrates aspects with respect to creating and provisioning context information 650 according to various examples. For example, the scenario of FIG. 22 may precede the scenario of FIG. 20.

At 3031, a registration request 2031 is received by the RAN 111 from the UE 101. The registration request message 2031 is for transitioning from the deregistered state 201 to the registered state 202 (cf. FIG. 4).

At 3032, the registration request message 2031 is forwarded by the RAN 111 to the AMF 131. Instead of purely forwarding the registration request 2031, it would also be possible that the RAN 111 generates the registration request to be transmitted at 3032 to the AMF 131 based on certain information received from the UE 101.

The AMF 131 can perform certain authorization tasks (not illustrated in FIG. 22) such as checking a subscription. The AMF 131 then transmits a registration accept message 2032 at 3033. This may correspond to transitioning the UE 101 from deregistered state 201 to the registered state 202. For example, at this point and in response to receiving the registration request message 2031, the AMF 131 may also create the identifier 655 such as the GUTI; this identifier 655 may be included in the registration accept message 2032.

Between step 3032-3033 and if needed security setup and negotiation of an NAS security context of the UE-AMF E2EE may be performed according to legacy procedures specified in 3GPP TS 23.502 and TS 33.501.

At 3034, the AMF 131 determines a device category of the UE 101. Then, depending on the device category of the UE, the AMF 131 may or may not proceed with creating context information 650 for the UP bearer 320 which is for routing the application data 304 piggybacked to the control message 301 (in FIG. 12 a scenario is illustrated in which the AMF 131 proceeds with creating the context information 650). Hence, the context information 650 may be selectively created. If not already created prior to 3034, it would also be possible that the identifier 655 uniquely associated with the UE 101 is created at this point; hence, it would be generally possible that the identifier 655 is selectively created, depending on the device category. For example, the identifier 655 could be created if the device category indicates a NB-IOT UE or, generally, if the device category prompts creation of the context information 650. Such conditional creation of the identifier 655 depending on the device category is optional.

Specifically, in the example of FIG. 22, at 3034, it is checked whether the device category of the UE 101 corresponds to NB-IOT UE or non-NB-IOT UE, i.e. the UE 101 use the feature of sending and receiving application data in NAS messages or not. If the device category corresponds to NB-IOT UE, then, at 3035, a PDU session establishment request message 2034 is transmitted by the AMF 131 and received by the SMF 132. The SMF 132 then establishes a PDU session as CN UP bearer 320 and creates context information 650 and transmits the latter to the nodes along the CN UP bearer 320, specifically to the UPF 121; in this regard, a session modification request message 2035 is transmitted by the SMF 132 and received by the UPF 121 at 3036; and a session modification response message 2036 is transmitted by the UPF 121 and received by the SMF 132 at 3037. Hence, an N3 tunnel may be created as part of the UP bearer.

The SMF 132 then confirms creation of the context information 650 by transmitting a PDU session response message 2037 to the AMF 131 at 3038. This PDU session response message 2037 includes the context information 650 which was previously also distributed to the UPF 121 using the session modification request message 2035.

At 3039, the AMF 131 then transmits a UE create context request message 2038 to the RAN 111 and, optionally, to the UE 101. The configuration update message 2038 includes the identifier 655 which has been previously created by the AMF 131 of the SMF 132, e.g., when creating the context information 650 or separately. It would be possible that the configuration update message 2038 also includes the context information 650, e.g., for locally storing of the context information 650 at the BS 112 of the RAN 111. In other examples, it would also be possible that the context information 650 is provided to the BS 112 in a separate control message, e.g., as described in connection with FIG. 20 above.

The UE 101 may then be operated in idle state 211: there may be no RAN UP bearer established between the UE 101 and the BS 112 on the wireless link 114. Nonetheless, a CN UP bearer may remain established or in suspended state, i.e., in active state. The BS 112 may retain locally the context information; or may fetch it on demand.

As will be appreciated from the description of FIGS. 20-22, it is possible that the context information 650 is provided to the BS 112 for routing of the application data in the UP at a point in time at which a CN UP bearer is not established on the wireless link 114 between the UE 101 and the BS 112. Hence, the CN UP bearer 320 may be established on the CN 115, but may not extend to the UE 101 via the wireless link 114. Hence, it is, in other words, possible that the UE 101 is registered as operating in the idle mode 211 or, generally, a non-connected mode, at least as a RAN 111 state. In the non-connected mode, the UE 101 may not be directly reachable using a UP bearer extending all the way to the UE 101; rather, paging of the UE may be required in order to reach the UE 101. Such techniques have the advantage that it is not required to burden the UE 101 with the task of locally setting up the RAN UP bearer, because establishment of the UP bearer is restricted to the CN 115. This helps to reduce power consumption at the UE 101 and reduce signalling overhead on the wireless link 114.

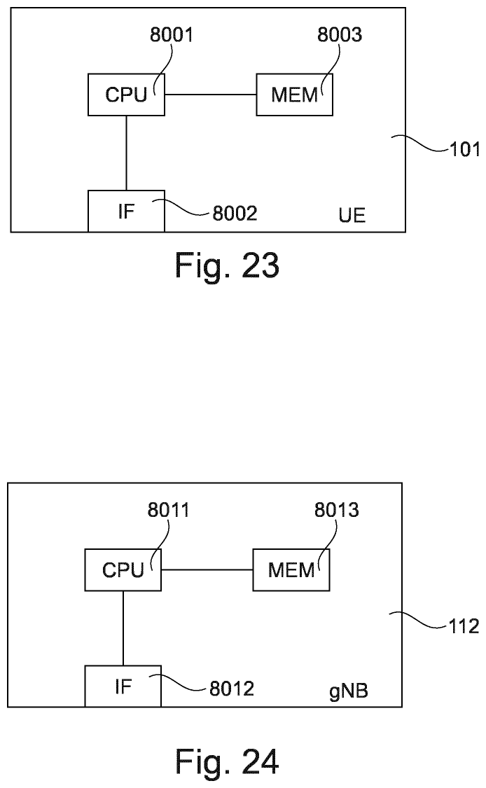

FIG. 23 schematically illustrates aspects with respect to the UE 101. The UE 101 includes control circuitry formed by a processor 8001 and a memory 8003. The UE 101 also includes an interface 8002 for wireless communication. The memory 8003 may be a non-volatile memory. Program code may be stored by the memory 8003. The program code may be loaded by the processor 8001 and may then be executed by the processor 8001. Executing the program code may cause the processor 8001 to perform techniques as described herein, e.g., with respect to: setting the value of an indicator to be included in a control message, e.g., based on the type of data; transmitting the control message; piggybacking application data to a control message; performing header compression and/or encryption; perform a RACH procedure; transmitting a RRC control message; maintaining and selecting between multiple instances of a security context of E2EE, e.g., depending on the value of an indicator; negotiating and re-negotiating security contexts, updating security contexts; cloning security contexts to obtain multiple instances; etc.

FIG. 24 schematically illustrates aspects with respect to the BS 112. The BS 112 includes control circuitry formed by a processor 8011 and a memory 8013. The BS 112 also includes an interface 8012 for wireless communication and CN communication. The memory 8013 may be a non-volatile memory. Program code may be stored by the memory 8013. The program code may be loaded by the processor 8011 and may then be executed by the processor 8011. Executing the program code may cause the processor 8011 to perform techniques as described herein, e.g., with respect to: receiving a control message; inspecting an information field of the control message; inspecting an indicator associated with the information field and, specifically, associated with data encapsulated in the information field; depending on a value of the indicator, selectively routing the data via a UP node or a CP node; performing proxy functionality on application data; acting as an endpoint of a CN UP bearer; transmitting a context request to a CP mobility node; routing the data based on context information associated with a UP bearer; establishing context information based on an identifier of a UE; performing (re-) negotiation of a respective instance of a security context; cloning a security context; transmitting and/or receiving (communicating) a request message for performing re-negotiation of a security context; providing and/or receiving an update of a respective instance of a security context; etc.

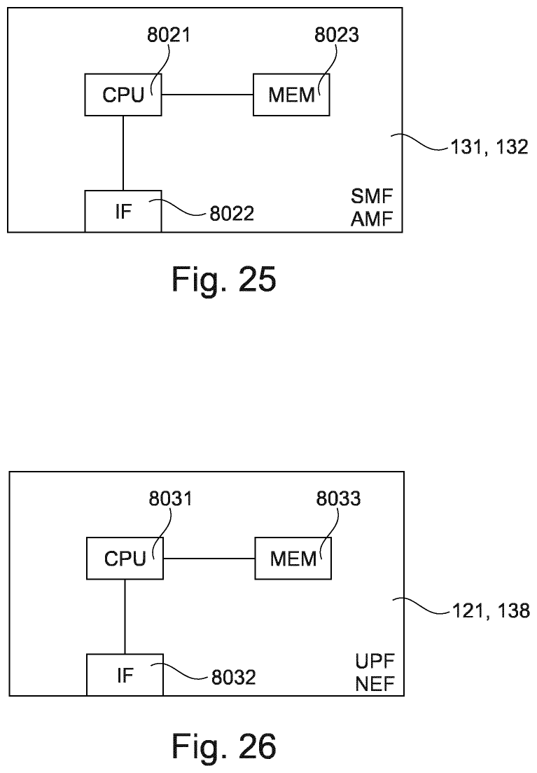

FIG. 25 schematically illustrates aspects with respect to the AMF 131 and the SMF 132. The AMF 131 and the SMF 132 each implement control-network mobility nodes. Generally, the AMF 131, as well as the SMF 132 may be configured according to the example of FIG. 15. In some scenarios, it would be possible that the AMF 131 and the SMF 132 are co-located at a common device. The AMF 131/SMF 132 includes control circuitry formed by a processor 8021 and the memory 8023. The AMF 131/SMF 132 also includes an interface 8022 for CN communication, e.g., on NAS layer. The memory 8023 may be a non-volatile memory. Program code may be stored in the memory 8023. The program code may be loaded by the processor 8021 and may then be executed by the processor 8021. Executing the program code may cause the processor 8021 to perform techniques as described herein, e.g., with respect to: receiving a registration request of a UE attempting to register with the network; based on device category of the UE; selectively creating context information of a UP bearer, specifically a CN UP bearer; transmitting the context information to a least one endpoint of the UP bearer, e.g., in response to receiving a context request; creating an identifier of the UE; performing a path switch of the UP bearer in response to detecting UE mobility, by setting a new endpoint; terminating NAS control messages; performing (re-)negotiation of a respective instance of a security context; cloning a security context; transmitting and/or recovering (communicating) a request message for performing re-negotiation of a security context; providing and/or receiving an update of a respective instance of a security context; etc.

FIG. 26 schematically illustrates aspects with respect to the UPF 121 and the NEF 138. The UPF 121 and the NEF 138 each implement gateway nodes, because they can forward application data between the network and a further data network. Generally, the UPF 121, as well as the NEF 138 may be configured according to the example of FIG. 16. In some examples, it would be possible that the UPF 121 and the NEF 138 are colocated at a common device. The UPF 121/NEF 138 includes control circuitry formed by a processor 8031 and a memory 8033. The UPF 121/NEF 138 also includes an interface 8032 for CN communication. The memory 8033 may be a non-volatile memory. Program code may be stored in the memory 8033. The program code may be loaded by the processor 8031 and may then be executed by the processor 8031. Executing the program code may cause the processor 8031 to perform techniques as described herein, e.g., with respect to routing data along a UP bearer where the data can be application data that has been communicated on a respective wireless link piggyback to a control message; performing proxy functionality; routing data along a CP UP bearer; performing (re-) negotiation of a respective instance of a security context; cloning a security context; transmitting and/or receiving (communicating) a request message for performing re-negotiation of a security context; providing and/or receiving an update of a respective instance of a security context; etc.

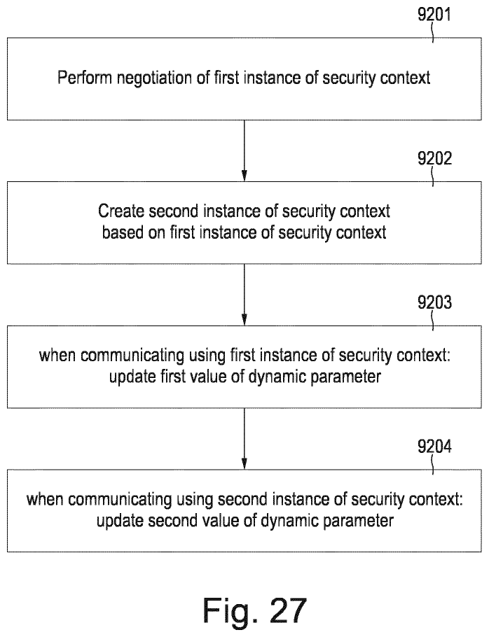

FIG. 27 is a flowchart of a method according to various examples. For example, the method according to FIG. 27 could be executed by the control circuitry of the UE 101. For example, the method according to FIG. 27 could be implemented by the terminal node 51 of FIG. 1.

First, at block 9201, a negotiation of a first instance of a security context is performed. For example, this may relate to negotiation of an NAS-level security context of an E2EE between the UE 101 and the AMF 131 (cf. FIGS. 9 and 10). For example, the NAS security context could be negotiated as part of the registration procedure (cf. FIG. 22, blocks 3031-3033).

Then, at block 9202, a second instance of the security context is created based on the first instance of the security context. For example, the first instance of the security context may be copied. For example, it would be possible to copy the respective values of one or more static parameters from the first instance of the security context to create the second instance of the security context. Alternatively or additionally, it would be possible to copy the respective seed values of one or more dynamic parameters from the first instance of the security context when creating the second instance of the security context.

Next, at block 9203, a first value of a dynamic parameter of the security context is updated when communicating using the first instance of the security context. Here, one or more messages may be received and/or transmitting using cryptographic functionality implemented based on the first instance of the security context. Hence, the first value of the dynamic parameter is associated with the first instance of the security context. For example, if the respective method according to the scenario of FIG. 27 is applied in the context of an NAS-level security context, then the respective dynamic parameter may be NAS count according to 3GPP TS 33.401, version 15.0.0 (2017-06), FIG. B.1-1: ciphering of data. Here, static parameters may include the cryptographic keys such as the 128-bits cipher key named key.

When communicating using the second instance of the security context, at block 9204, a second value of the respective dynamic parameter—e.g., the counter—is updated. At 9024, one or more messages may be communicating using cryptographic functionality implemented based on the second instance of the security context.

Maintaining two distinct values of the dynamic parameter associated with the different instances at blocks 9203 and 9204 helps to avoid out-of-sync encryption between the respective endpoints. Specifically, it would be possible that, at block 9203, the first instance of the security context is used when encrypting or decrypting NAS-level control data (cf. block 773 in FIG. 18); while it would be possible that the second instance of the security context is used at block 9204 then encrypting or decrypting application-layer data (cf. block 703 of FIG. 18).

The method may further include setting or reading the value of an indicator to select between the used instance of the security context (not illustrated in FIG. 27). The indicator facilitates selection of the appropriate instance of the security context, in particular where different instances of the same message are routed differently depending on the indicator (cf. FIGS. 17-19).

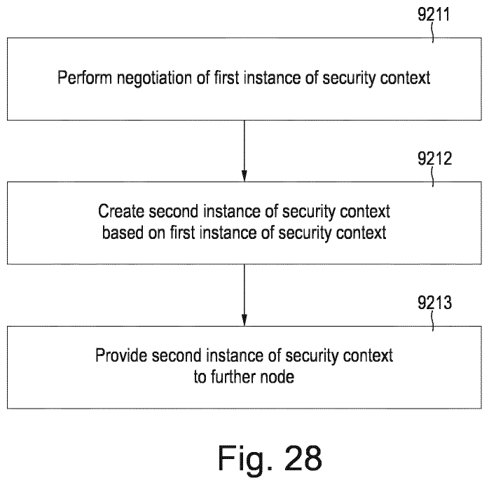

FIG. 28 is a flowchart of a method according to various examples. For example, the method according to FIG. 28 could be performed by the control circuitry of the BS 112, the AMF 131, the UPF 121, and/or the NEF 138. For example, the method according to FIG. 28 could be executed by control circuitry of one of the nodes 55-57 according to the example of FIG. 1.

At block 9211, the negotiation of a first instance of a security context of an E2EE is performed. As such, block 9211 may be inter-related with block 9201. Next, at block 9212, a second instance of the security context is created based on the first instance of the security context. As such, block 9212 may correspond to block 9202 of FIG. 27.

Then, at block 9213, the second instance of the security context is provided to a further node. Thereby, implementing E2EE between different end nodes and a terminal node is facilitated. For example, if the method according to FIG. 28 is executed by the AMF 131, at block 9213, the second instance of the security context may be provided to one or more of the UPF 121, the NEF 138, and the BS 112, for respective E2EE with the UE 101 (cf. FIG. 18: block 713; and FIG. 19: block 783).

For example, block 9213 may be implemented as a push communication. Hence, providing the second instance of the security context to the further node may be proactively initiated by the respective node from which the second instance of the security context originates. Thereby, it is possible to provide the second instance of the security context including the negotiated parameter such as a security algorithm, dynamic parameters and cryptographic keys to the further node. By providing the second instance of the security context to the further node, it becomes possible to communicate between a terminal node in two different end nodes using E2EE using the same cryptographic keys, but by independently updating one or more dynamic parameters (cf. FIG. 27: blocks 9203, 9204).

In the context of the NAS-level encryption according to the examples of FIGS. 18 and 19, the second instance of the security context may be selectively created and provided to the further node in blocks 9212, 9213 for such users that implement NB-10T functionality of embedding application-layer data in an NAS control message. Whether or not a given user implements such CIoT functionality may be determined depending on a category of the UE 101 and/or details of the respective subscription (cf. FIG. 22: block 3034).

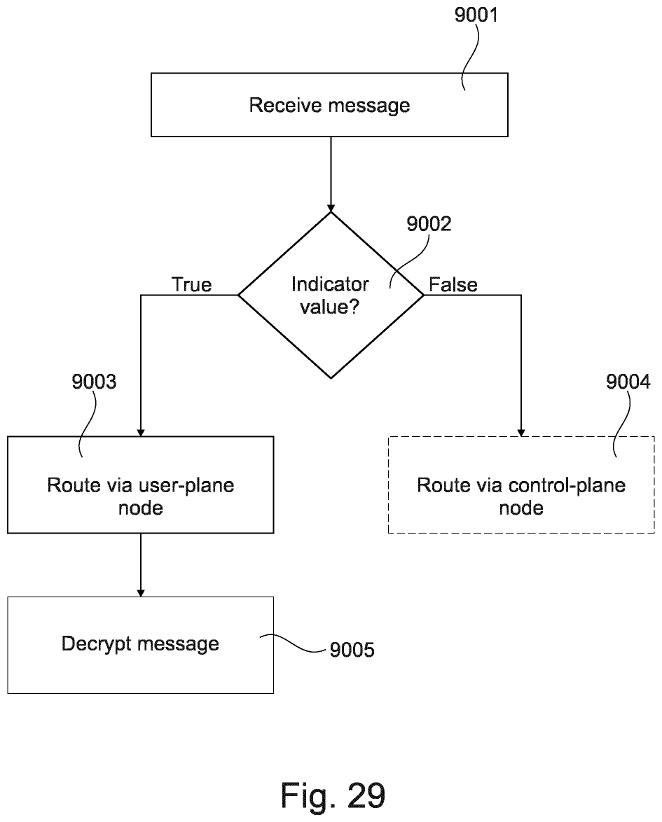

FIG. 29 is a flowchart of a method according to various examples. For example, the method according to the example of FIG. 17 could be performed by control circuitry of the BS 112. Optional blocks are marked with dashed lines.

In other examples, it would be possible that the method according to the example of FIG. 29 is performed by a CN node, e.g., a gateway node such as the UPF 121 or the NEF 138. This may, in particular, be applicable where DL data is communicated from an application server in a data network 180 towards a UE 101.

At block 9001, a message is received. For example, a control message such as an RRC control message may be received (cf. FIG. 14). The message may be received on an SRB or as part of a RACH procedure of a UE (cf. FIG. 13). The message may be received on a wireless link. For example, the message may be received on a wireless link 114 of a network operating according to the 3GPP 5G protocol (cf. FIGS. 9 and 10). The message may include an information field in which data is encapsulated. The information field may be for control signalling. For example, the message may include a further control message in the information field which further control message, in turn, includes the data in a payload section. Further, the message includes an indicator, e.g., a one-bit flag. The indicator may or may not be part of the information field. It is an option to include the indicator of a header of the further control message included in the information of the message.

At block 9002, the value of the indicators checked. Depending on the outcome of that check—i.e., depending on the value—the method either commences at block 9003 or at block 9004 (also cf. FIGS. 18 and 19). At block 9003, the data encapsulated and the information field is routed via an UP node, e.g., a UPF in the 3GPP 5G framework. Here, a CN UP bearer may be used. The UP node may or may not implement gateway functionality; one-hop or multi-hop routing in the UP are possible.

At block 9004—which is generally an optional step—, the data encapsulated in the information field is routed to a CP node, e.g., a CP mobility node such as the AMF in the 3GPP 5G framework. Here, a CN CP bearer may be used. Since the indicator value is False the information field is an NAS control message. Instead of routing the data via the CP node at block 9004, other implementations are conceivable for the respective branch of the method flow, e.g., discarding the data, etc.

If block 9003 is executed, it is possible that at optional block 9005 proxy functionality—e.g., cryptographic functionality, including decrypting, and/or header compression functionality, including decompressing—is performed. Block 9005 may be performed by the BS; or may be performed by another node such as the UP node to which the BS routes the data. When decrypting at block 9005, a respective instance of a security context may be used; e.g., a second instance of an NAS-level security context provided by the AMF 131 may be used (cf. FIG. 28: block 9213).

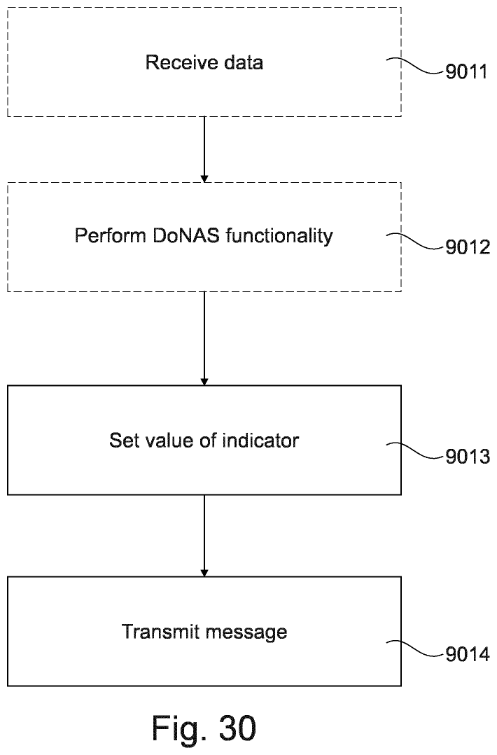

FIG. 30 is a flowchart of a method according to various examples. For example, the method according to the example of FIG. 30 could be performed by control circuitry of the UE 101. Optional blocks are marked using dashed lines.

At block 9011—which is an optional block—, data such as higher-layer data or, specifically, application data which is sometimes also referred to as payload data user data is received. The data may be received in a transmit buffer, e.g., on Layer 3. The data may be queued for transmission on a wireless link.

Next, at block 9012—which is again an optional block—, data over NAS (DoNAS) functionality is performed on the data. The DoNAS functionality may include cryptographic functionality, i.e., encrypting and/decrypting. Alternatively or additionally, the DoNAS functionality may include header compression, i.e., compressing and/or decompressing depending on the scenario (cf. FIGS. 18 and 19). At block 9012, a respective instance of a security context may be used; e.g., a second instance of an NAS-level security context.

At block 9013, the value of an indicator is set. The value may be set depending on a type of the data received at block 9011. For example, if the type of the data corresponds to control data—e.g., NAS control data or, generally, Layer 3 control data—, then a first value may be selected for the indicator; differently, the type of the data corresponds to application data—which generally originates from a layer above the layer of the control data—, then a second value different from the first value may be selected for the indicator. Thus, generally, the value of the indicator may be set depending on a layer of a transmission protocol stack from which the data received at block 9011 originates from and/or a type of the data.

At block 9014, a message is transmitted. The message includes an information field which encapsulates the data; also, the message includes the indicator having the value set accordingly at block 9013. The information field may be for control signalling; as such, the message may be referred to as control message. Yet, the information field may not be exclusively reserved for control signalling—rather, it would be possible that the information field is re-used for communication of application data.

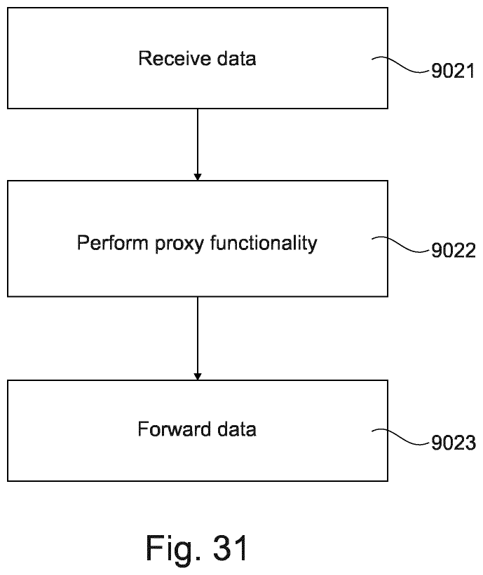

FIG. 31 is a flowchart of a method according to various examples. For example, the method according to the example of FIG. 31 could be performed by control circuitry of the UPF 121 and/or by control circuitry of the NEF 138. Generally, the method according to the example of FIG. 31 could be performed by a CN node, specifically, by a gateway node.

At block 9021, data is received. The data may be received from a CN node or a BS. The data may be received using CN signalling. The data may be received on a CN UP bearer. The data may be received from a data network.

At block 9022, proxy functionality is performed. The proxy functionality may include header compression functionality and/or cryptographic functionality. Optionally, the value of an indicator associated with the data may be set. When encrypting at block 9022, a respective instance of a security context may be used; e.g., a second instance of an NAS-level security context provided by the AMF 131 may be used (cf. FIG. 28: block 9213).

At block 9023, the data is forwarded, e.g., to another CN node or to a data network.

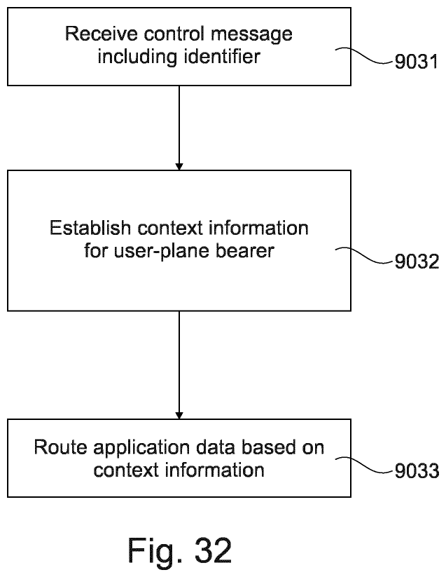

FIG. 32 is a flowchart of a method according to various examples. For example, the method according to the example of FIG. 32 could be performed by the control circuitry of the BS 112. In an alternative scenario, the method according to the example of FIG. 32 could also be executed by a gateway node of the network when receiving DL data from a data network different from the network.

At block 9031, a control message is received. The control message includes an identifier uniquely allocated to a UE from which the control message is received. For example, the identifier may be a CN identifier. For example, the identifier may be the 3GPP 5G GUTI.

There is also application data piggybacked to the control message. For example, the application data could be encapsulated in an information field which is for control signalling between the UE and a CP mobility node such as an AMF or SMF in the 3GPP 5G framework. The application data could be included in a further control message included in the information field of the control message, e.g., in a payload section of the further control message.

Next, at 9032, context information is established for a UP bearer to be used when routing the application data. Establishing the context information may relate to: searching for the pre-created context information and/or retrieving the pre-created context information. In one example, the context information may be retrieved from a CP mobility node such as an AMF or SMF in the 3GPP 5G framework; to this end, respective context request message may be transmitted to the CP mobility node which triggers a context response message including the context information. An alternative option would be to load the preprovisioned context information from a local memory. The context information may be associated with the identifier.

Once the context information has been established, at block 9033, the application data is routed using the UP bearer based on the context information. For example, the application data may be routed to a UP node such as the UPF or a gateway node.

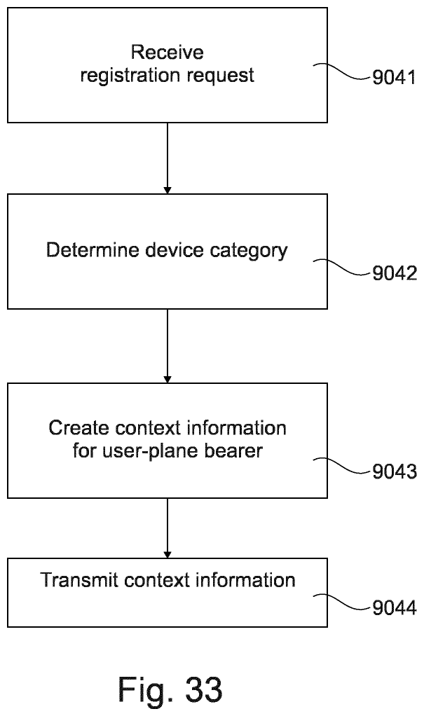

FIG. 33 is a flowchart of a method according to various examples. For example, the method according to the example of FIG. 21 could be performed by the control circuitry of the AMF 131 and/or the SMF 132.

First, at block 9041, a context information request message is received. The registration request message is transmitted by the BS or another node of a RAN. The registration request message is for registering a UE at the network. Hence, prior to receiving a registration request at block 9041, the UE may be operated in the deregistered state (cf. FIG. 12).

At block 9042, a device category is determined for the UE. This may be based, at least partly, on information included in the registration request message. It would be possible that determining the device category is, at least partly, based on information retrieved from a data repository of the CN. Specifically, at block 9042, can be checked whether the device category indicates that the UE is capable of piggybacking application data to control messages for communication on the wireless link. This may be the case for the device category NB-IOT UE. Alternatively or additionally, it may be checked whether the UE is capable of terminating a RAN UP bearer.

If the device category corresponds to one or more certain predefined target device categories, then, at 9043, context information for a UP bearer is created (cf. FIG. 16). For example, in a 3GPP 4G scenario, the UP bearer may be implemented by the Evolved Packet System (EPS) bearer; while in the 3GPP 5G scenario, the UP bearer may be implemented by a PDU session. Otherwise, the context information may not be created. Hence, the context information may be selectively created, depending on the device category. The context information may include data required for routing along the UP bearer, e.g., cryptographic keys, for communicating on the bearer tunnel identifiers, etc.

As will be appreciated from FIG. 33, the creation of the context information is in response to receiving the registration request, subject to the correct device category. Thus, the context information is generated while—or potentially even prior to—transitioning the UE from deregistered state to registered state (cf. FIG. 12). This is different certain reference implementations where a dedicated service request or RRC resume control message may be required to trigger creation of the context information, after operation of the UE has been transitioned into registered state. Thereby, latency may be reduced and the UE may be relieved from the burden of sending the service request or RRC resume control message; specifically, this may be helpful in scenarios where the UE does not have the capability of terminating a RAN UP bearer.

At 9044, the context information is transmitted. For example, the context information could be transmitted to a BS via which the registration request message has been received at block 9041. Alternatively or additionally, the context information could be transmitted to one or more endpoints of the UP bearer, to thereby configure these endpoints appropriately for routing the data. Alternatively or additionally, the context information could be transmitted to one or more intermediate nodes of the UP bearer.

Summarizing, techniques have been described which enable to implement negotiation and re-negotiation of security contexts of E2EE between a terminal node and multiple different end nodes at low latency and resource efficient. This is achieved by relying on multiple instances of a security context. For example, a first instance of a security context of an E2EE can be negotiated once and then re-used by multiple end nodes. The multiple end nodes may be part of the same trusted domain.

Such techniques are generally applicable to different security protocols. Examples of protocols include 3GPP NAS which uses a receive and transmit counter to avoid replay attacks. A further example of a protocol is OMA DM that uses a Nonce to avoid replay attacks. Such dynamic parameters may be partially created at the negotiation or re-negotiation, e.g., a respective seed value may be determined. By cloning multiple instances of the security context, such seed values may be propagated, thereby releasing the different end nodes of the task of individual negotiation of the security context.

Re-negotiation of the security context may become due to different reasons, e.g., security validation/verification or, generally, detecting an untrusted security level. Also in response to re-negotiation of a given instance of the security context, that given instance may be cloned to the other end nodes.

Various dynamic parameters can be considered in the techniques illustrated above. Examples of dynamic parameters include counters per message. For example, separate counters for transmitting and receiving may be implemented. It would also be possible rely on dynamic parameters which implement a common counter for transmitting and receiving. A further example of a dynamic parameter is a Nonce, which is a random string/token communicated in one direction to be used for the next message in the other direction.

Such techniques of cloning of security context can be applied for different use cases. One use case is separation of CP and UP in accordance with a CIoT scenario. As explained above, this is achieved by selectively routing data included in an information field piggybacked to a control message via the UP or the CP, e.g., depending on the value of the indicator. To this end, it is possible that different instances of a security context are employed in accordance with the value of the indicator, because of the different end nodes involved due to the different routing. For example, a NAS control message may be decoded or encoded using different instances of a security context in accordance with the value of the indicator.

In at least some of the foregoing examples, user data packets are routed to the core network via the control plane by cloning a security context between core network nodes. Such techniques can be complemented or replaced by further techniques, some of which are described below.

The solution described above uses the same cryptographic key (e.g., KNASenc) for encryption in all endpoints in the core network, e.g., to the AMF 131 (“normal NAS”) and to a NB-IoT NAS Security Proxy (“NAS user data”) such as the NEF 138. However, in some scenarios sharing security keys could be considered inappropriate. Therefore, it may be preferred that the NAS key is not shared between nodes in the network. In some scenarios, this may offer improved security.

Sharing cryptographic keys can at least partly avoided by generation of a new cryptographic key for various nodes. For instance, a first cryptographic key can be created for a first node such as the AMF 131 and further cryptographic keys can be created for the other node(s) than the first node. The new cryptographic key may be generated based on the existing cryptographic key or and one or more additional parameters. The new cryptographic key may be generated in a way similar to how the cryptographic keys are generated for the BSs 112. But in this case, it is proposed to generate the new cryptographic key used in the additional node based on a subscriber identity associated with the UE 101 known by both the UE 101 and the CN 192. An example subscriber identity would be the Temporary Mobile Subscriber Identity (TMSI), since TMSI is known by (i.e., shared) both the UE and Core Network.

As a general rule, “known by” can generally refer to the particular information element being stored in a local memory of the respective device or node such that one or more functions can be executed based on load the information element from the local memory.

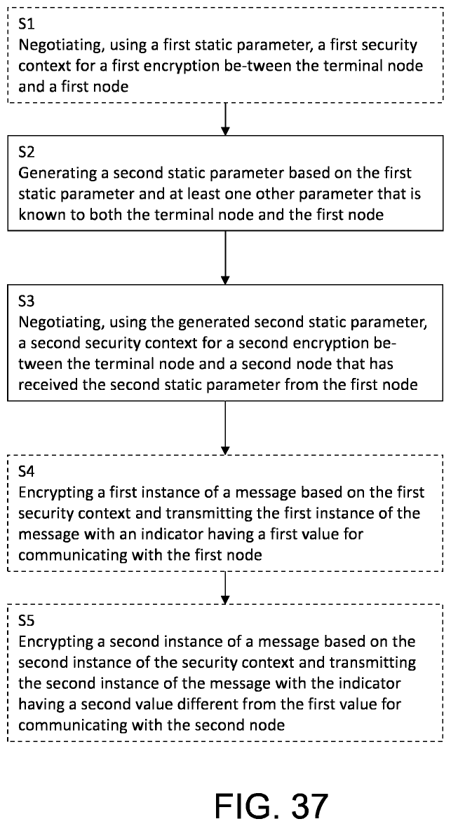

Details of this technique will now be described with reference to the signalling diagram of FIG. 34 and the flowcharts of FIG. 37 and FIG. 38 and FIG. 39. The methods will be described with reference to a first node 55 and a second node 56, but it must be appreciated that the method may be (re-)performed for each one of a plurality of further nodes 56, 57.

FIG. 37 illustrates a method of operating a terminal node 51. The terminal node 51 is e.g. a UE 101. The terminal node 51 communicates with a first node 55. For example, the first node may be an AMF 131. For example, the techniques of FIG. 37 may be used for generating a security context for a second node 56, 57 in the CN 192 based on a cryptographic key used a first node in the CN 192. Then, the first node 51 can also communicate with the second node 56, 57.

Details with respect to the security contexts have been described in connection with FIGS. 1 and 2 and can also be applied to the scenario discussed here.

In the example of FIG. 37, a first static parameter is known by the terminal node 51 and a first node 55. In other words, the first static parameter is shared (“a shared secret”) between the terminal node 51 and the first node 55. Other nodes may not be aware of the first static parameters, e.g., other nodes of the network or third-party nodes. By using the shared secret, the cryptographic key can be derived independently at the terminal node 51 and the first node 55; still, security can be enforced vis-á-vis other nodes and third parties.

In some embodiments, the first static parameter is used for a first encryption 61′ between the terminal node 51 and the first node 55 using a first security context. Thus, in some embodiments the method comprises negotiating S1, using a first static parameter, a first security context for a first encryption between the terminal node and the first node 55 (cf. also FIG. 34, where the negotiating S1 and first encryption 61′ is illustrated). The first static parameter may be a first cryptographic key.

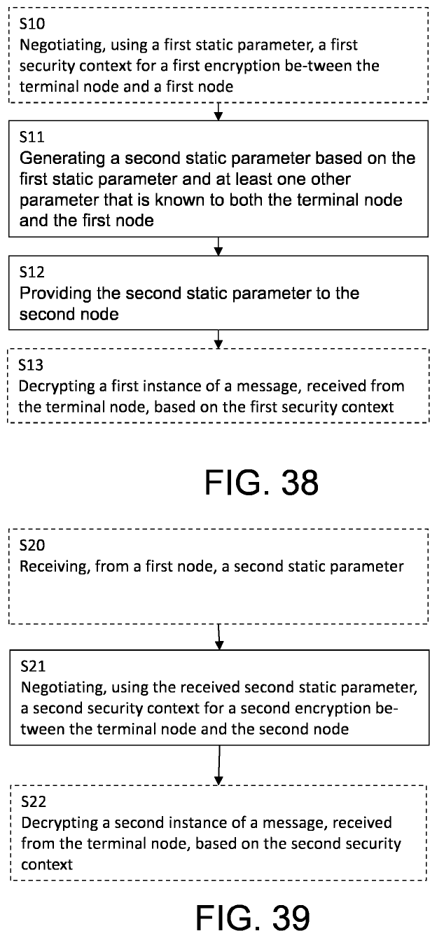

To avoid exposing the first static parameter, the method further includes generating S2 a second static parameter based on the first static parameter and at least one other parameter that is known to both the terminal node 51 and the first node 55 (also cf. FIG. 34 where the generating S2 at the terminal node 51 is illustrated; and FIG. 38 and FIG. 34 where the inter-related generating S11 at the first node 55 is illustrated). In other words, the second static parameter is calculated or determined (generated) based on the first static parameter and one or more further parameters that are known to both the terminal node 51 and the first node 55.

The first and second static parameters may be cryptographic keys.

In some embodiments, the one or more further parameters that are known to both the terminal node 51 and the first node 55 may include a subscriber identity associated with the terminal node 51 such as a TMSI or an International Mobile Subscriber Identity (IMSI). A further example of the one or more further parameters would be a Cryptographic scheme ID. Multiple such other parameters may be used in generating the static parameter.

The second static parameter may be determined in the terminal node 51 and/or in the first node, respectively, using predetermined criteria, e.g., a certain key derivation scheme. The used predetermined criteria is known to both the terminal node and the first node, e.g. through standardisation and/or signalling. A key derivation scheme may define one or more rules that determine a cryptographic key based on one or more of input parameters, random values, and calculation schemes.

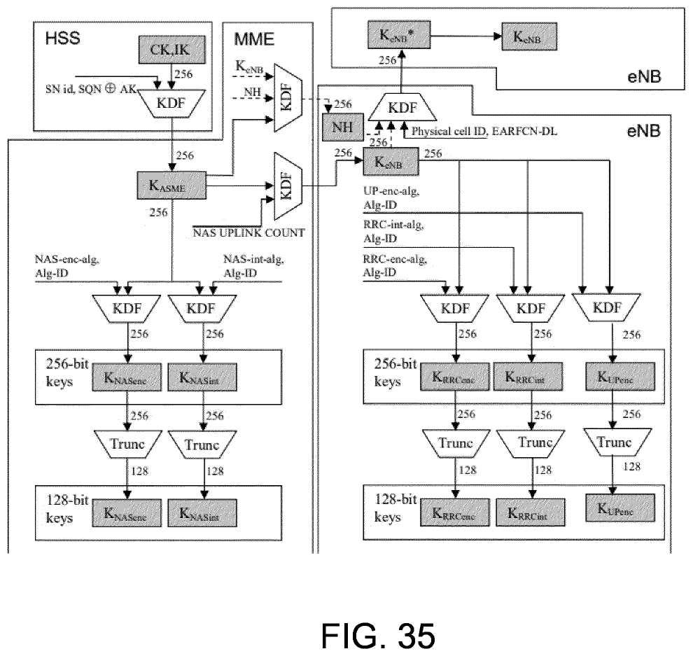

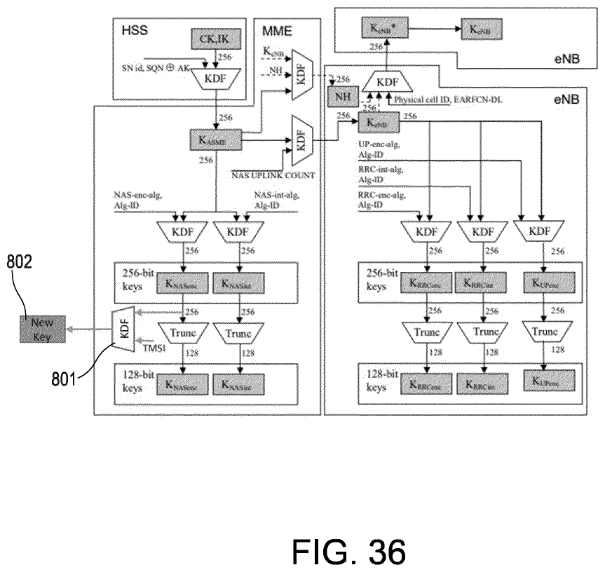

In other words, the second node may instead of (as above) using same first static parameter (e.g. cryptographic key) as the first node for the encryption/decryption, use a new cryptographic key generated from the key derivation scheme based on the same “basic cryptographic key” as the first static parameter and one additional parameter. The key derivation scheme is e.g. the 3GPP Key Distribution Function (FIG. 35 and FIG. 36; in FIG. 36 the key derivation scheme 801 used to generate the second cryptographic key 802 is illustrated) used for EPS for network nodes (see 3GPP TS 33.401, version 15.0.0) with an addition for this new key.

For example, instead of (as above) using the first cryptographic key KNASenc as basic cryptographic key for the encryption/decryption for payload data via UP, it is possible to use a new cryptographic key 802 generated from a key derivation scheme 801 based on KNASenc and TMSI (in FIG. 36, an un-truncated version of the first cryptographic key KNASenc is used as an input to the key derivation scheme 801).

In other words, in some embodiments, the first and second static parameters are generated by the terminal node 51 and the first node 55 using, at least partly, the same cryptographic key derivation 801 scheme at each node. Alternatively, the derivation scheme 801 can also be different for generation of the first and second cryptographic key.

With continued reference to FIG. 37, the method further comprises negotiating S3, using the generated second static parameter, a second security context for a second encryption 62′ between the terminal node 51 and a second node 56, 57 that has received the second static parameter from the first node 55 (also cf. FIG. 34 where the negotiating at the terminal node 51 is illustrated; and FIG. 34 and FIG. 39 where the inter-related negotiating at the second node 56, 57 is illustrated). As part of this security negotiation and in the case where the common known additional parameter is the Cryptographic scheme ID, then the terminal node 51 may generate the second static parameter after receiving a security negotiation message from the second node 56, 57 (alternative S2 in FIG. 34)

In this variant of the disclosure separate security contexts, i.e., the first and the second security context, are used for communicating with the first and the second nodes (cf.

FIG. 34: first encryption 61′ and second encryption 62′). Here, the security contexts can use static parameters (e.g., cryptographic keys) that are generated using the same basic cryptographic key. This means that in this variant, the second security context is not dependent on the first security context and re-negotiation of the second security context is not needed when the first security context is re-negotiated.

Furthermore, as the security contexts of the different nodes are separate contexts (not clones as above), they may have their individual dynamic parameters. In other words, each security context will have one (or a set of) dynamic parameters that are independently updated. Thus, a first value of a first dynamic parameter associated with the first security context is updated in response to communicating with the first node using the first security context and a second value of a second dynamic parameter associated with the second security context is updated in response to communicating with the second node using the second security context.

In some embodiments, the terminal node 51 is a terminal 101 accessing a network via a radio access network of the network.

In some embodiments, the first node 55 is a core-network mobility node of the network and the second node 56, 57 is at least one of a node that terminates the communication from the terminal node 51, a gateway node of the network providing access to a further network, and a base station of the radio access network of the network.

The separate security contexts may be used in the same way as described above in relation to FIG. 1-27, since after the cloning instances of the context will be different as the dynamic parameters will change. However, in this scenario, instead of using a first and a second instance of a security context, the first and second security contexts will be used. In other words, in some embodiments, the method comprises encrypting a first instance of a message 71 based on the first security context and transmitting the first instance of the message with an indicator—such as the indicator 302 described above—having a first value for communicating with the first node and encrypting a second instance of a second message based on the second security context and transmitting the second instance of the message with the indication having a second value different from the first value for communicating with the second node. Then, routing according to, e.g., FIGS. 17 to 19 can be employed.

In some embodiments, the message is a Non-Access Stratum control message 370, wherein the message is transmitted piggybacked to a Radio Resource Control message 301, 301. The techniques described above in connection with FIG. 14 or FIG. 15 can be applied.

In some embodiments, the method further comprises selecting between the first security context and the second security context based on an originating transmission protocol layer of payload of the respective instance of the message. Specifically, in the illustrated scenario, the NAS control message may be encrypted, by the terminal node 51—e.g., the UE 101—using the first security context when routed to the AMF 131 or may be encrypted, by the UE 101, using the second security context when routed via the UP. If NAS control data originating from Layer 3 is included in the NAS control message 370, then, the first security context can be selected; if, however, application-layer data is included in the NAS control message 370, then the second security context can be selected for encryption. Thus, as a general rule, a security layer may determine what security context to encrypt the NAS messages based on the content of the message is coming from the application or from the NAS signalling. The originating layer is either application layer or NAS signalling layer.

FIG. 38 is a flowchart of a corresponding method in a first node 55 according to various examples. Optional blocks are marked with dashed lines. More specifically, FIG. 38 illustrates a method of operating a first node 55, wherein the first node 55 shares a first static parameter with a terminal node 51. In FIG. 38, a security context for one or more second nodes 56, 57 is generated. For instance, the first node may be the AMF 131 in the CN 192 (cf. FIG. 9). FIG. 38 illustrates aspects with respect to generating a security context for another node in the CN 192 based on a key used by the AMF 131.

The method comprises generating S11 a second static parameter based on the first static parameter and at least one other parameter that is known to both the terminal node 51 and the first node 55.

For example, the NAS Security Proxy instead of using KNASenc as basic key for the encryption/decryption, it is proposed that it should use a new key generated from a KDF function based on KNASenc and TMSI. Note that TMSI is used here, but it can be any other commonly (both in UE and AMF) known input for the KDF (Key Derive Function), e.g., another subscriber identity.

The method optionally further comprises providing S12 the second static parameter to the one or more second node 56, 57 (also cf. FIG. 34 where this providing is illustrated).

The method optionally further comprises decrypting S13 a first instance of a message received from the terminal node 51 based on the first security context as negotiated S10.

This has been described in connection with FIG. 34, first encryption 61′.

In some embodiments the first node 55 and the one or more second node 56, 57 are part of the same trusted domain.

If the concept would be used for multiple second nodes 56, 57, then each second node 56, 57 may be provided with a separate new key based on some other common known parameters between (i) each second node 56, 57 and (ii) the terminal node 51 and/or the first node 55. In this way, it may be avoided that the second nodes 55, 56 share the same key.

FIG. 39 is a flowchart of a corresponding method in a second node according to various examples. Optional blocks are marked with dashed lines. FIG. 39 is inter-related with FIG. 38. For instance, the second node may be the UPF 121 or the NEF 138 of the CN 192.

S20 is inter-related with S12 of FIG. 38. Here, a second static parameter is received (also cf. FIG. 34 where this receiving is illustrated).

In S21 a second security context is then negotiated using the received second static parameter.

In S22, a second instance of a message is decrypted, using the second security context. This has been described in connection with FIG. 34, second encryption 62′.

Summarizing, the following examples have been described:

Example 1. A method of operating a terminal node (51, 101), comprising:
performing a negotiation (2501, 2031-2032) of a first instance of a security context (60, 61-1) for a first encryption (61) between the terminal node (51, 101) and a first node (55, 131),
based on the negotiation (2501, 2031-2032) of the first instance of the security context (60, 61-1): creating a second instance of the security context (60, 62-1, 63-1) for a second encryption (62, 63) between the terminal node (51, 101) and a second node (56, 57, 112, 121, 138, 132),
updating a first value of a dynamic parameter (69) associated with the first instance of the security context (60, 61-1) in response to communicating with the first node (55, 131) using the first instance of the security context (60, 61-1), and
updating a second value of the dynamic parameter (69) associated with the second instance of the security context (60, 62-1, 63-1) in response to communicating with the second node (56, 57, 112, 121, 138, 132) using the second instance of the security context (60, 62-1, 63-1).

Example 2. The method of example 1, further comprising:
when performing the negotiation (2501, 2031-2032) of the first instance of the security context (60, 61-1): determining a seed value of the dynamic parameter (69),
wherein the first value of the dynamic parameter (69) is updated based on the seed value,
wherein the second value of the dynamic parameter (69) is updated based on the seed value.

Example 3. The method of examples 1 or 2, further comprising:
detecting an untrusted security level for said communicating with the second node (56, 57, 112, 121, 138, 132) using the second instance of the security context (60, 62-1, 63-1),
in response to said detecting of the untrusted security level: performing a re-negotiation of the first instance of the security context (60, 61-1) of the first encryption with the first node (55, 131), and
updating the second instance of the security context (60, 62-1, 63-1) based on the re-negotiation.

Example 4. The method of any one of the preceding examples, further comprising:
detecting an untrusted security level for said communicating with the second node (56, 57, 112, 121, 138, 132) using the second instance of the security context (60, 62-1, 63-1),
in response to said detecting of the untrusted security level: performing a re-negotiation of the second instance of the security context (60, 62-1, 63-1) of the second encryption with the second node (56, 57, 112, 121, 138, 132), and
updating the first instance of the security context (60, 61-1) based on the re-negotiation.

Example 5. The method of any one of the preceding examples,
wherein the terminal node (51, 101) is a terminal (101) accessing a network (100) via a radio access network (111) of the network (100).
   wherein the first node (55, 131) is a core-network mobility node (131) of the network (100),
   wherein the second node (56, 57, 112, 121, 138, 132) is at least one of a node that terminates the communication from the terminal node (51, 101), a gateway node (112, 121, 138) of the network (100) providing access to a further network (180), and a base station (112) of the radio access network (111) of the network.

Example 6. The method of any one of the preceding examples, further comprising:
encrypting a first instance of a message (71, 370, 2011) based on the first instance of the security context (60, 61-1) and transmitting the first instance of the message with an indicator (302) having a first value for communicating with the first node (55, 131), and
encrypting a second instance of a message (72, 370, 2011) based on the second instance of the security context (60, 62-1, 63-1) and transmitting the second instance of the message with the indicator (302) having a second value different from the first value for communicating with the second node (56, 57, 112, 121, 138, 132).

Example 7. The method of example 6,
wherein the message is a Non-Access Stratum control message (370),
wherein the message is transmitted piggybacked to a Radio Resource Control message (301, 301A).

Example 8. The method of examples 6 or 7, further comprising:
selecting between the first instance of the security context (60, 61-1) and the second instance of the security context (60, 62-1, 63-1) based on an originating transmission protocol layer of payload of the respective instance of the message (71, 72, 370).

Example 9. A method of operating a first node (55, 131), comprising:
performing a negotiation (2501, 2031-2032) of a first instance of a security context of a first encryption (61) between the first node (55, 131) and a terminal node (51, 101),
based on the negotiation (2501, 2031-2032) of the first instance of the security context (60, 62-1): creating a second instance of the security context (60, 62-2, 63-2) for a second encryption (62, 63) between a second node (56, 57, 112, 121, 138, 132) and the terminal node (51, 101), and
providing the second instance of the security context (60, 62-2, 63-2) to the second node (56, 57, 112, 121, 138, 132).

Example 10. The method of example 9, further comprising:
detecting an untrusted security level when communicating with the terminal node (51, 101) using the first instance of the security context (60, 62-1),
in response to said detecting of the untrusted security level: performing a re-negotiation of the first instance of the security context (60, 62-1), and
providing an update (2504) of the second instance of the security context (60, 62-2, 63-2) to the second node (56, 57, 112, 121, 138, 132) based on the re-negotiation.

Example 11. The method of examples 9 or 10, further comprising:
receiving, from the second node (56, 57, 112, 121, 138, 132), a request message (2511),
in response to said receiving of the request message (2511): performing a re-negotiation of the first instance of the security context (60, 62-1), and
providing an update (2504) of the second instance of the security context (60, 62-2, 63-2) to the second node (56, 57, 112, 121, 138, 132) based on the re-negotiation.

Example 12. The method of any one of examples 9-11,
wherein the first node (55, 131) and the second node (56, 57, 112, 121, 138, 132) are part of the same trusted domain.

Example 13. A terminal node comprising control circuitry configured to perform:
performing a negotiation (2501, 2031-2032) of a first instance of a security context (60, 61-1) for a first encryption (61) between the terminal node (51, 101) and a first node (55, 131),
   based on the negotiation (2501, 2031-2032) of the first instance of the security context (60, 61-1): creating a second instance of the security context (60, 62-1, 63-1) for a second encryption (62, 63) between the terminal node (51, 101) and a second node (56, 57, 112, 121, 138, 132),
   updating a first value of a dynamic parameter (69) associated with the first instance of the security context (60, 61-1) in response to communicating with the first node (55, 131) using the first instance of the security context (60, 61-1), and
   updating a second value of the dynamic parameter (69) associated with the second instance of the security context (60, 62-1, 63-1) in response to communicating with the second node (56, 57, 112, 121, 138, 132) using the second instance of the security context (60, 62-1, 63-1).

Example 14. The terminal node of example 13,
wherein the control circuitry is configured to perform the method of any one of examples 1-8.

Example 15. A first node comprising control circuitry configured to perform:
performing negotiation (2501, 2031-2032) of a first instance of a security context of a first encryption (61) between the first node (55, 131) and a terminal node (51, 101),
based on the negotiation (2501, 2031-2032) of the first instance of the security context (60, 62-1): creating a second instance of the security context (60, 62-2, 63-2) for a second encryption (62, 63) between a second node (56, 57, 112, 121, 138, 132) and the terminal node (51, 101), and
providing the second instance of the security context (60, 62-2, 63-2) to the second node (56, 57, 112, 121, 138, 132).

Example 16. The first node of example 15,
wherein the control circuitry is configured to perform the method of any one of examples 9-12.

Example 1A. A method of operating a terminal node (51, 101), wherein a first static parameter is known by the terminal node (51, 101) and a first node (55, 131), the method comprising:
generating (S1) a second static parameter based on the first static parameter and at least one other parameter that is known to both the terminal node (51, 101) and the first node (55, 131), and
negotiating (S2), using the generated second static parameter, a second security context (60, 62-1, 63-1) for a second encryption (62, 63) between the terminal node (51, 101) and a second node (56, 57, 112, 121, 138, 132) that has received the second static parameter from the first node (55, 131).

Example 2A. The method of example 1A, wherein the first and second static parameters are cryptographic keys.

Example 3A. The method of example 2A, wherein the first and second static parameters are generated by the terminal node and the first node using, at least partly, the same cryptographic key derivation scheme at each node.

Example 4A. The method of any of the preceding examples 1A to 3A, wherein the at least one other parameter that is known to both the terminal node (51, 101) and the first node (55, 131) is a subscriber identity associated with the terminal node (51, 101) or a Cryptographic scheme ID.

Example 5A. The method of any one of the preceding examples 1A to 4A,
wherein the terminal node (51, 101) is a terminal (101) accessing a network (100) via a radio access network (111) of the network (100).
   wherein the first node (55, 131) is a core-network mobility node (131) of the network (100), wherein the second node (56, 57, 112, 121, 138, 132) is at least one of a node that terminates the communication from the terminal node (51, 101), a gateway node (112, 121, 138) of the network (100) providing access to a further network (180), and a base station (112) of the radio access network (111) of the network.

Example 6A. The method of any one of the preceding examples 1A to 5A, wherein the first static parameter is used for a first encryption (61) between the terminal node (51, 101) and the first node (55, 131) using a first security context, the method further comprising:
encrypting a first instance of a message (71, 370, 2011) based on the first security context (60, 61-1) and transmitting the first message with an indicator (302) having a first value for communicating with the first node (55, 131), and
encrypting a second instance of a message (72, 370, 2011) based on the second security context (60, 62-1, 63-1) and transmitting the second message with the indicator (302) having a second value different from the first value for communicating with the second node (56, 57, 112, 121, 138, 132).

Example 7A. The method of any one of the preceding examples 1A to 6A,
wherein the message is a Non-Access Stratum control message (370),
wherein the message is transmitted piggybacked to a Radio Resource Control message (301, 301A).

Example 8A. The method of any one of the preceding examples 1A to 7A, further comprising:
selecting between the first security context (60, 61-1) and the second security context (60, 62-1, 63-1) based on an originating transmission protocol layer of payload of the respective instance of the message (71, 72, 370).

Example 9A. A method of operating a first node (55, 131), wherein a first static parameter is known by the terminal node (51, 101) and the first node (55, 131), the method comprising:
generating (S11) a second static parameter based on the first static parameter and at least one other parameter that is known to both a terminal node (51, 101) and the first node (55, 131); and
   providing (S12) the second static parameter to a second node (56, 57, 112, 121, 138, 132),
      wherein the first static parameter is known by the terminal node (51, 101) and a first node (55, 131).

Example 10A. The method of example 9A,
wherein the first node (55, 131) and the second node (56, 57, 112, 121, 138, 132) are part of the same trusted domain.

Example 11A. A terminal node (51) comprising control circuitry configured to perform:
generating (S1) a second static parameter based on a first static parameter and at least one other parameter that is known to both the terminal node (51, 101) and the first node (55, 131), and
negotiating (S2), using the generated second static parameter, a second security context (60, 62-1, 63-1) for a second encryption (62, 63) between the terminal node (51, 101) and a second node (56, 57, 112, 121, 138, 132) that has received the second static parameter from the first node (55, 131),
   wherein the first static parameter is known by the terminal node (51, 101) and a first node (55, 131).

Example 12A. The terminal node of example 11A,
wherein the control circuitry is configured to perform the method of any one of examples 1A-8A.

Example 13A. A first node (55) comprising control circuitry configured to perform:
generating (S11) a second static parameter based on a first static parameter and at least one other parameter that is known to both a terminal node (51, 101) and the first node (55, 131), the first static parameter being known by the terminal node (51, 101) and the first node (55, 131); and
   providing (S12) the second static parameter to a second node (56, 57, 112, 121, 138, 132),
      wherein the first static parameter is known by the terminal node (51, 101) and a first node (55, 131).

Example 14A. The first node of example 13A,
wherein the control circuitry is configured to perform the method of any one of examples 9A-10A.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above various examples have been described in which an RRC control message encapsulates application data in an NAS information field. However, in other examples, other kinds and types of control messages may be used in order to piggyback application data, e.g., Layer 2 or Layer 1 control messages.

For further illustration, various examples have been described above in which the indicator is included in the same message in which the application data or control data is included. In other examples, the indicator may be included in another message that may be associated with the message including the application data or control data.

For further illustration, various aspects—e.g., regarding RRC control message encapsulation and including an indicator—have been described in connection with respect to a scenario of cloning security contexts. Similar techniques may also be applied to scenarios in which a first security context is used to derive a second security context.

For further illustration, above various examples have been described in which UL application data is encapsulated in the information field of the UL control message. In other examples, DL application data may be encapsulated in a DL control message. Here, proxy and routing functionality may reside at the GW node—e.g., the NEF or the UPF—instead of at the BS. The UE may select between different instances of the security context for decryption depending on the value of an indicator appropriately set by the GW node or the BS, and the AMF.

For still further illustration, while above various scenarios have been described with respect to non-IP application data, similar techniques may be readily applied to IP application data; here, instead of using a NEF GW node, a UP GW node such as a UPF may provide interfacing to the data network, e.g., using the N6 reference point in the 3GPP 5G NR framework.

For still further illustration, above various scenarios have been described in which non-IP application data is routed to a data network via the CP NEF node. This is an example implementation only; in other examples, it would be possible to use a different GW to the data network for non-IP application data, e.g., a UP UPF.

For example, various scenarios have been described in which different end nodes employing E2EE with a terminal node are implemented by the AMF, as well as the GNB, the UPF, or the NEF. This is in the context of NAS-layer encryption in a CIOT scenario. However, the techniques of cloning security contexts are not limited to such a scenario and may be flexibly applied in any scenario which benefits from E2EE.

For still further illustration, above various scenarios have been described with respect to E2EE—while, generally, the techniques may also be applied for other kinds and types of encryption.

1. A method of operating a terminal node, wherein a first static parameter is known by the terminal node and a first node, the method comprising:
generating a second static parameter based on the first static parameter and at least one other parameter that is known to both the terminal node and the first node, and
negotiating, using the second static parameter, a second security context for a second encryption between the terminal node and a second node that has received the second static parameter from the first node.

2. The method of claim 1, wherein the first static parameter and the second static parameter are cryptographic keys.

3. The method of claim 2, wherein the first static parameter and the second static parameter are generated by the terminal node and the first node using, at least partly, the same cryptographic key derivation scheme at each node.

4. The method of claim 1, wherein the at least one other parameter that is known to both the terminal node and the first node is a subscriber identity associated with the terminal node or a cryptographic scheme ID.

5. The method of claim 1,
wherein the terminal node is a terminal accessing a network via a radio access network of the network,
wherein the first node is a core-network mobility node of the network,
wherein the second node is at least one of a node that terminates communication from the terminal node, a gateway node of the network providing access to a further network and a base station of the radio access network of the network.

6. The method of claim 1,
wherein the first static parameter is used for a first encryption between the terminal node and the first node using a first security context, the method further comprising:
encrypting a first instance of a message based on the first security context and transmitting the first instance of the message with an indicator having a first value for communicating with the first node, and
encrypting a second instance of the message based on the second security context and transmitting the second instance of the message with the indicator having a second value different from the first value for communicating with the second node.

7. The method of claim 6,
wherein the message is a non-Access Stratum control message,
wherein the message is transmitted piggybacked to a Radio Resource Control message.

8. The method of claim 6, further comprising:
selecting between the first security context and the second security context based on an originating transmission protocol layer of payload of the respective instance of the message.

9. A method of operating a first node, wherein a first static parameter is known by a terminal node and the first node, the method comprising:
generating a second static parameter based on the first static parameter and at least one other parameter that is known to both the terminal node and the first node; and
providing the second static parameter to a second node.

10. The method of claim 9,
wherein the first node and the second node are part of the same trusted domain.

11. A terminal node comprising a control circuitry configured to perform:
generating a second static parameter based on a first static parameter and at least one other parameter that is known to both the terminal node and a first node, and
negotiating, using the second static parameter, a second security context for a second encryption between the terminal node and a second node that has received the second static parameter from the first node.

12. The terminal node of claim 11,
wherein the control circuitry is configured to perform the method of claim 1.

13. A first node comprising control circuitry configured to perform:
generating a second static parameter based on a first static parameter and at least one other parameter that is known to both a terminal node and the first node, the first static parameter being known by the terminal node and the first node; and
providing the second static parameter to a second node.

14. The first node of claim 13,
wherein the control circuitry is configured to perform the method of claim 1.
